(19) United States
(12) Patent Application Publication
(10) Pub. No.: US 2025/0100838 A1
(43) Pub. Date: Mar. 27, 2025

(54) MEDIUM PROCESSING APPARATUS AND IMAGE FORMING SYSTEM

(71) Applicants: Kazuki MISHINA, Kanagawa (JP); Kei SASAKI, Kanagawa (JP); Kazuki SETO, Kanagawa (JP); Kohta ABE, Kanagawa (JP)

(72) Inventors: Kazuki MISHINA, Kanagawa (JP); Kei SASAKI, Kanagawa (JP); Kazuki SETO, Kanagawa (JP); Kohta ABE, Kanagawa (JP)

(73) Assignee: Ricoh Company, Ltd., Ohta-ku, Tokyo (JP)

(21) Appl. No.: 18/833,250

(22) PCT Filed: Feb. 6, 2023
(86) PCT No.: PCT/IB2023/051023

§ 371 Date: Jul. 25, 2024

(30) Foreign Application Priority Data
Feb. 7, 2022 (JP) 2022-017347
Dec. 2, 2022 (JP) 2022-193643

(51) Int. Cl. B65H 37/04

(52) U.S. Cl. CPC B65H 37/04; B65H 2301/5142; B65H 2301/51616; B65H 2511/15; B65H 2801/06; B65H 2801/27

(57) ABSTRACT

A medium processing apparatus includes a liquid applier, a crimper, and a controller. The liquid applier includes a liquid application member to apply liquid to a part of a medium. The crimper presses and deforms a bundle of media including the medium to which the liquid is applied by the liquid applier, to bind the bundle of media. The controller causes the liquid application member to move with respect to the medium, based on height information of the medium, so that an amount of the liquid applied to the medium by the liquid application member is equal to a designated amount.

### TECHNICAL FIELD

Embodiments of the present disclosure relate to a medium processing apparatus and an image forming system incorporating the medium processing apparatus.

### BACKGROUND ART

Medium processing apparatuses are known that perform binding on a sheet bundle, which is a bundle of sheet-shaped media on which images are formed. Some medium processing apparatuses are also known that perform binding without metal binding needles (i.e., staples) from a viewpoint of resource saving and reduction in environmental load. Such medium processing apparatuses include a crimper that can perform so-called “crimp binding.”

Specifically, the crimper sandwiches a sheet bundle with serrate binding teeth to press and deform the sheet bundle. Sheets of paper are widely known as an example of sheet-shaped media. Therefore, in this specification, when describing a bundle of sheets, the term “sheet bundle” is used as an example of a bundle in which a plurality of sheets as media are stacked.

As the thickness of the sheet bundle increases or the number of sheets in the sheet bundle increases, the binding teeth are less likely to bite into the sheet bundle and the retaining force for retaining the bound state weakens. For example, the bound sheets may be peeled off, and it is difficult to maintain the bound state. To increase the binding strength in a medium processing apparatus that performs crimp binding, a technique is known in which water is added in advance to a position (hereinafter, referred to as a “binding position”) at which the binding teeth come into contact with sheets so that the binding teeth easily bite into the sheets (for example, refer to PTL 1).

### CITATION LIST

### Patent Literature

PTL 1

Japanese Unexamined Patent Application Publication No. 2014-201432

### SUMMARY OF INVENTION

### Problem to be Solved

In the technique disclosed in PTL 1, water is added to each of sheets of a sheet bundle. When the number of sheets in the sheet bundle increases, the relative positions of a water adding unit and a sheet change. The amount of water added by the water adding unit varies depending on the amount of movement by which the water adding unit moves for contacting the sheet. Accordingly, if the amount of movement of the water adding unit varies in one water adding operation, the amount of water added varies. As a result, a problem arises that the amount of water added excessively increases and a sufficient binding force is not obtained at the time of crimping.

An object of the present disclosure is to provide a medium processing apparatus that performs a liquid application operation with a suitable liquid application amount even when the number of sheets of a sheet bundle or a sheet type varies.

### Solution to Problem

According to an aspect of the disclosure, a medium processing apparatus includes a liquid applier, a crimper, and a controller. The liquid applier includes a liquid application member to apply liquid to a part of a medium. The crimper presses and deforms a bundle of media including the medium to which the liquid is applied by the liquid applier, to bind the bundle of media. The controller causes the liquid application member to move with respect to the medium, based on height information of the medium, so that an amount of the liquid applied to the medium by the liquid application member is equal to a designated amount.

### Advantageous Effects of Invention

According to an embodiment of the present disclosure, a liquid application operation can be performed with a suitable liquid application amount even when the number of sheets of a sheet bundle or a sheet type varies.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram illustrating an overall configuration of an image forming system according to an embodiment of the present disclosure.

FIG. 2 is a diagram illustrating the internal configuration of a post-processing apparatus according to a first embodiment of the present disclosure.

FIG. 3 is a schematic view of an internal tray of the post-processing apparatus according to the first embodiment, viewed from an upper surface side of the internal tray.

FIG. 4 is a schematic view of a binder of the post-processing apparatus according to the first embodiment, viewed from an upstream side of the binder in a conveyance direction.

FIG. 5 is a schematic view of the binder according to the first embodiment, viewed from the side on which a liquid applier is disposed in a main scanning direction.

FIGS. 6A and 6B are schematic diagrams illustrating the configuration of a crimper of the post-processing apparatus according to the first embodiment.

FIG. 7 is a block diagram illustrating the hardware configuration of controlling operations of the post-processing apparatus according to the first embodiment.

FIGS. 8A and 8B are diagrams illustrating an example of the thickness of a sheet bundle and an operation mode of the liquid applier.

FIGS. 9A and 9B are diagrams illustrating another example of the thickness of the sheet bundle and the operation mode of the liquid applier.

FIG. 10 is a flowchart of a procedure of binding to crimp and bind a sheet bundle at a binding position in the post-processing apparatus according to the first embodiment.

FIG. 11 is a flowchart illustrating an initial setting process in a first example of a liquid application process in the binding.

FIG. 12 is a flowchart illustrating the first example of the liquid application process in the binding.

FIG. 13 is a flowchart illustrating a second example of the liquid application process in the binding.

FIGS. 14A and 14B are schematic views of a liquid application member according to a third example of the liquid application process in the binding.

FIG. 15 is a flowchart illustrating the third example of the liquid application process in the binding.

FIGS. 16A and 16B are schematic views of a liquid application member according to a fourth example of the liquid application process in the binding.

FIG. 17 is a flowchart illustrating the fourth example of the liquid application process in the binding.

FIG. 18 is a flowchart illustrating an initial setting process in a fifth example of the liquid application process in the binding.

FIGS. 19A and 19B are schematic views of a liquid application member according to the fifth example of the liquid application process in the binding.

FIG. 20 is a flowchart illustrating the fifth example of the liquid application process in the binding.

FIGS. 21A and 21A are schematic views of a liquid application member according to a sixth example of the liquid application process in the binding.

FIG. 22 is a flowchart illustrating the sixth example of the liquid application process in the binding.

FIG. 23 is a diagram illustrating the internal configuration of a post-processing apparatus according to a second embodiment of the present disclosure;

FIGS. 24A, 24B, and 24C are schematic views of an internal tray of the post-processing apparatus according to the second embodiment, viewed from a thickness direction of a sheet.

FIG. 25 is a schematic view of a crimper of the post-processing apparatus according to the second embodiment, viewed from an upstream side in a conveyance direction.

FIGS. 26A and 26B are schematic views of a liquid applier of the post-processing apparatus according to the second embodiment, viewed from the thickness direction of the sheet;

FIGS. 27A, 27B, and 27C are cross-sectional views of a liquid application unit of the liquid applier taken through XXV-XXV of FIG. 26A.

FIGS. 28A, 28B, and 28C are cross-sectional views of the liquid application unit of the liquid applier taken through XXVI-XXVI of FIG. 26A.

FIG. 29 is a block diagram illustrating the hardware configuration of controlling the operation of the post-processing apparatus according to the second embodiment.

FIG. 30 is a flowchart of post-processing performed by the post-processing apparatus according to the second embodiment.

FIG. 31 is a diagram illustrating the overall configuration of an image forming system according to a modification of the embodiment illustrated in FIG. 1.

### DESCRIPTION OF EMBODIMENTS

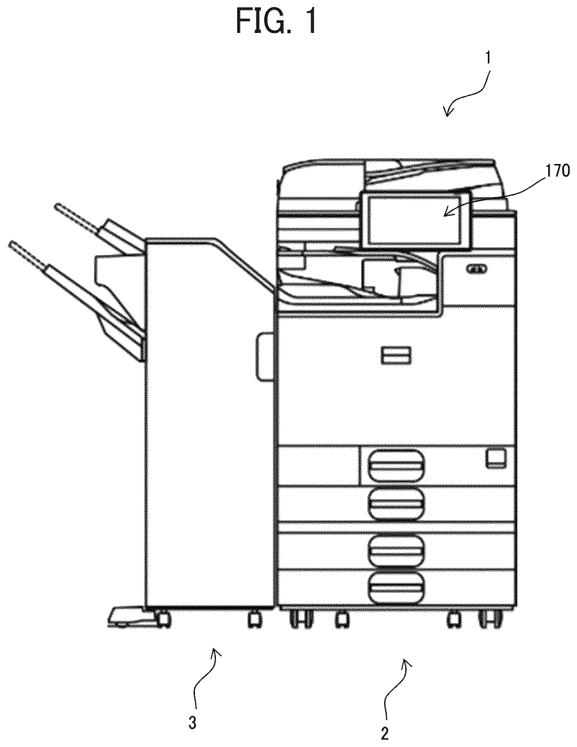

Initially, a description is given of a first embodiment of the present disclosure. With reference to the drawings, a description is now given of image forming system 1 serving as an image forming system according to an embodiment of the present disclosure. FIG. 1 is a diagram illustrating the overall configuration of the image forming system 1. The image forming system 1 has a function of forming an image on a sheet P as a sheet-shaped medium and performing post-processing on the sheet P on which the image is formed. As illustrated in FIG. 1, the image forming system 1 includes an image forming apparatus 2 and a post-processing apparatus 3 serving as a medium processing apparatus according to an embodiment of the present disclosure. In the image forming system 1, the image forming apparatus 2 and the post-processing apparatus 3 can operate in conjunction with each other. The image forming apparatus 2 forms an image on the sheet P and outputs the sheet P bearing the image to the post-processing apparatus 3. The image forming apparatus 2 mainly includes a storage tray in which sheets P are stored, a conveying unit that conveys the sheets P stored in the storage tray, and an image forming unit that forms an image on the sheets P conveyed by the conveying unit. The image forming unit may be an inkjet image forming device that forms an image with ink or an electrophotographic image forming device that forms an image with toner. Since the image forming apparatus 2 has a typical configuration, a detailed description of the configuration and functions of the image forming apparatus 2 are omitted.

A description is given below of the outline of the post-processing apparatus 3. Next, a description is given below of the outline of the post-processing apparatus 3 as a medium conveyance device according to an embodiment of the present disclosure. The post-processing apparatus 3 includes an overlay conveyance section 250 as a retreat conveyance passage. The overlay conveyance section 250 enables “pre-stacking” in which a preceding medium conveyed in advance is temporarily retreated to a switchback conveyance passage and a plurality of subsequent media conveyed subsequently are overlaid with the preceding medium. The preceding medium and the subsequent media aligned by the pre-stacking are conveyed to the internal tray 260, which is described below, in an aligned state.

The retreat conveyance passage is disposed upstream from the internal tray 260, which serves as a medium placement tray, in the conveyance direction of the sheet P.

The post-processing apparatus 3 performs designated post-processing on the sheet P ejected from the image forming apparatus 2 as a host apparatus. The post-processing executed in the post-processing apparatus 3 may be controlled by a control block included in the post-processing apparatus 3, as described later, based on information from the host apparatus or may be controlled by a control block included in the host apparatus.

The post-processing apparatus 3 includes, as conveyors, an entry conveyance section 210 continuing from the entry port that receives the sheet P ejected by the image forming apparatus 2, an upper-shift ejection conveyance section 220 and a lower-shift ejection conveyance section 230 that branch off on the downstream side of the entry conveyance section 210, and the overlay conveyance section 250.

The entry conveyance section 210 is provided with a punching unit PU that performs punching processing on the sheet P conveyed into the post-processing apparatus 3. The sheet P having passed through the entry conveyance section 210 is conveyed to an upper shift tray 227 via the upper-shift ejection conveyance section 220, conveyed to a lower shift tray 236 via the lower-shift ejection conveyance section 230, or conveyed to the overlay conveyance section 250. The sorting of the conveyance destinations of the sheet P is performed by a first branch claw bc1 and a second branch claw bc2 serving as separators disposed at a branch point of the conveyance passage.

The overlay conveyance section 250 is provided with a third branch claw bc3. The third branch claw bc3 switches the conveyance destination of the sheet P between the internal tray 260 conveyed through an overlay conveyance passage D as a first conveyance passage and a retreat conveyance passage E as a second conveyance passage conveyed in reverse.

In the entry conveyance section 210, a plurality of conveyance roller pairs (hereinafter, also simply referred to as conveyance roller pairs) 211, 212, 213, and 214 are arranged on an entry conveyance passage A from the entry port. The punching unit PU is disposed between the conveyance roller pair 213 and the conveyance roller pair 214.

The first branch claw bc1 is disposed downstream from the conveyance roller pair 214 in the conveyance direction of the sheet P. Switching the state of the first branch claw bc1 allows the conveyance direction of the sheet P to be switched to any one of the upper-shift conveyance passage B, the lower-shift conveyance passage C, and the overlapping conveyance passage D. The second branch claw bc1 is further disposed downstream from the first branch claw bc2 in the conveyance direction of the sheet P. Switching the state of the second branch claw bc2 allows the conveyance direction of the sheet P to be switched to the upper-shift conveyance passage B or the lower-shift conveyance passage C.

The upper-shift ejection conveyance section 220 is provided with a plurality of pairs of conveyance rollers (hereinafter also simply referred to as conveyance roller pairs) 221, 222, 223, and 225, which arranged to form an upper-shift conveyance passage B. The sheet P having passed through the upper-shift conveyance passage B is ejected to the upper shift tray 227. An upper shift sensor 226 for detecting that the sheet P is ejected to the upper shift tray 227 is disposed in the vicinity of the exit port.

In the lower-shift ejection conveyance section 230, a plurality of pairs of conveyance rollers (hereinafter, also simply referred to as conveyance roller pairs) 231, 232, and 233 are arranged to form the lower-shift conveyance passage C. Lower shift sensors 234 and 235 for detecting that the sheet P is ejected to the lower shift tray 236 are disposed in the vicinity of the exit port.

The overlay conveyance passage D is formed in the overlay conveyance section 250. The third branch claw bc3 is disposed on the overlapping conveyance passage D. A plurality of pairs of conveyance rollers (hereinafter, also simply referred to as conveyance roller pairs) such as a upstream conveyance roller pair 251, a downstream conveyance roller pair 252, a contact-separation conveyance roller pair 253, a retreat conveyance roller pair 254, and a internal-tray ejection roller pair 255 are arranged in the overlay conveyance section 250.

More specifically, the upstream conveyance roller pair 251 is disposed upstream from the third branch claw bc3, and the downstream conveyance roller pair 252 is disposed downstream from the third branch claw bc3. The contact-separation conveyance roller pair 253 is disposed between the upstream conveyance roller pair 251 and the downstream conveyance roller pair 252 and downstream from the third branch claw bc3. The retreat conveyance roller pair 254 is disposed in the retreat conveyance passage E.

The sheet P conveyed from the upstream side to the downstream side in the overlay conveyance section 250 is conveyed to the internal tray 260 as a conveyance destination through the internal-tray ejection roller pair 255. The sheet P ejected to the internal tray 260 is detected by the medium detection sensor 257 and is notified to the controller 100 described later. Accordingly, the number of sheets P that have passed through the medium detection sensor 257 toward the internal tray 260 is detected by the medium detection sensor 257, and the controller 100 determines whether the number of sheets P has reached the number of sheets of the sheet bundle Pb in the binding process described later.

In the internal tray 260, alignment for aligning ends of a plurality of sheets P and liquid application for applying liquid to a binding position are performed. Then, binding is performed on the aligned end of the sheet bundle Pb by the binder 25. The sheet bundle Pb as a medium bundle subjected to the binding is ejected to the lower shift tray 236 via the lower-shift conveyance passage C.

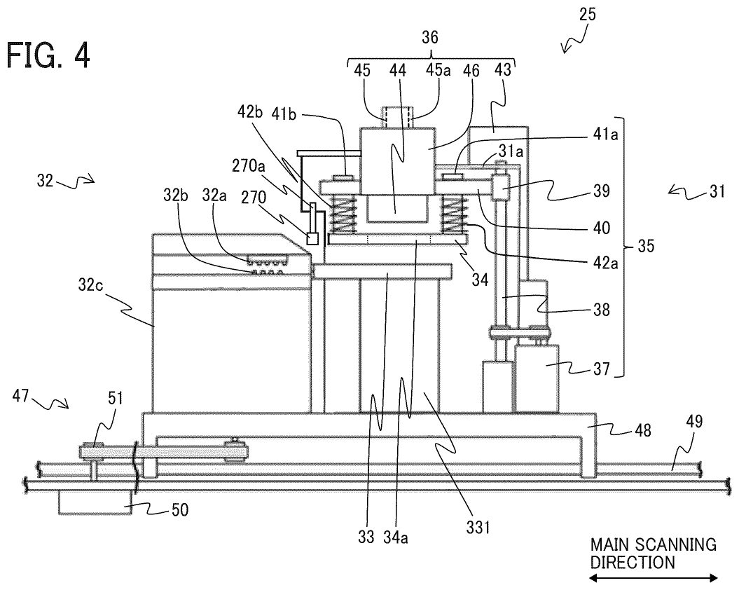

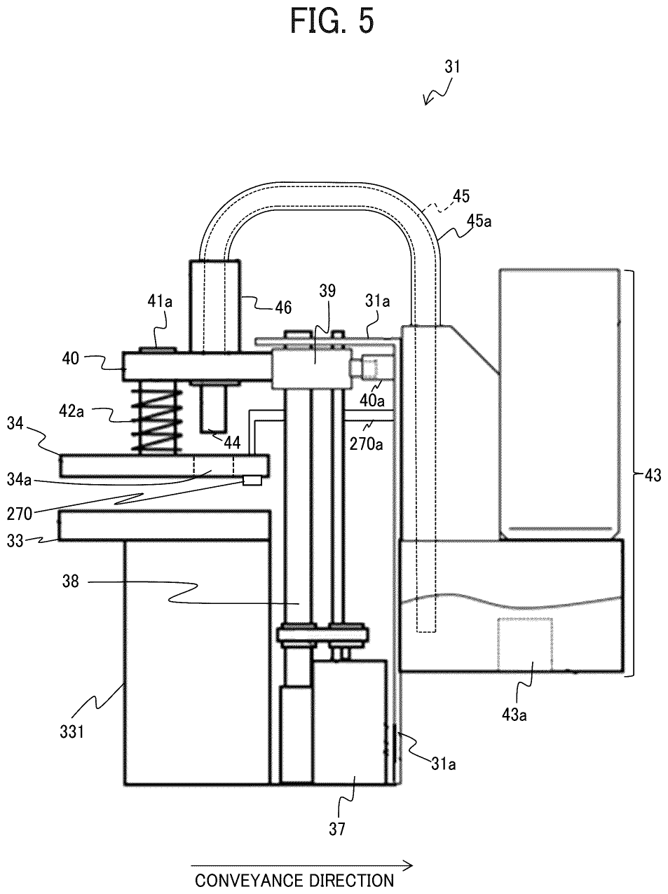

A distance measuring sensor 270 for measuring the number of sheets P stacked on the internal tray 260 is disposed. As illustrated in FIGS. 4 and 5, the distance measuring sensor 270 is attached to a liquid application frame 31a via a holding member 270a. As described above, the distance measuring sensor 270 is disposed near the liquid application member 44 of the liquid applier 31, and thus can accurately measure, in the vicinity of the liquid application member 44, the distance to the uppermost surface of the sheet P or the sheet bundle Pb placed on the internal tray 260 (the distance between a contact portion of the liquid application member 44 with the sheet P or the sheet bundle Pb and the uppermost surface of the sheet P or the sheet bundle Pb) and the distance to the lower pressure plate 33 when the sheet P or the sheet bundle Pb is not placed on the internal tray 260 (the distance between a contact portion of the liquid application member 44 with the sheet P or the sheet bundle Pb and the lower pressure plate 33). The distance measuring sensor 270 is not limited to the case where the distance measuring sensor 270 is attached to the liquid application frame 31a as described above, and, for example, may be fixed to a fixed frame disposed on a body of the post-processing apparatus 3 such that the distance measuring sensor 270 faces the internal tray 260. Thus, since the distance measuring sensor 270 is always fixed at a constant position regardless of the movement of the liquid applier 31, the detection accuracy of the distance measuring sensor 270 can be stabilized.

The distance measuring sensor 270 is installed at a position serving as a predetermined reference point, and measures a distance from the reference point to the placement surface of the lower pressure plate 33 when no sheet P or sheet bundle Pb is placed on the internal tray 260, and a distance from the reference point to the uppermost surface of the sheet P or sheet bundle Pb placed on the internal tray 260. Thus, the controller 100 can calculate the distance from the contact surface of the liquid application member 44 with the sheet P or the sheet bundle Pb to the uppermost surface of the sheet P or the sheet bundle Pb placed on the internal tray 260 on the basis of the measurement result of the distance measuring sensor 270. Instead of the distance measuring sensor 207, a detector may be used that can measure the number of sheets P placed on the internal tray 260 and acquire the relative distance between the uppermost surface of the sheets P or the sheet bundle Pb placed on the internal tray 260 and the liquid application member 44. For example, a position detector (image sensor) capable of specifying the position of the uppermost surface of the sheet P or the sheet bundle Pb from an image may be used.

The controller 100 can also calculate the position of the uppermost surface of the sheet P or the sheet bundle Pb (the height from the placement surface of the lower pressure plate 33 to the uppermost surface of the sheet P or the sheet bundle Pb) without using the measurement result of the distance measuring sensor 207. That is, the controller 100 can also calculate the height of the sheet P or the sheet bundle Pb placed on the internal tray 260 by multiplying the number of sheets P measured by the medium detection sensor 257 by information (sheet thickness information d) of a predetermined sheet thickness value per sheet of the sheets P. The predetermined sheet thickness value per sheet of the sheets P may be a value automatically determined according to the type of sheet P (e.g., plain paper, thick paper, or thin paper) selected by the user, or may be a value designated by the user.

In any case, the height information as a numerical value representing the height of the sheet bundle Pb can be calculated by arithmetic processing of a computer program executed in the controller 100 described later.

In the post-processing apparatus 3, post-processing performed on the sheets P is processing for binding a bundle (sheet bundle Pb) of a plurality of sheets P on which images are formed. More specifically, the binding according to the present embodiment includes so-called “crimp binding” and “stapling.” The crimp binding is a process to press and deform the sheet bundle Pb at a binding position. The stapling is a process to bind the sheet bundle Pb with a staple. In the present specification, descriptions of configurations and operations related to stapling may be omitted.

A description is given of an example of the configuration of the binder 25 and the internal tray 260.

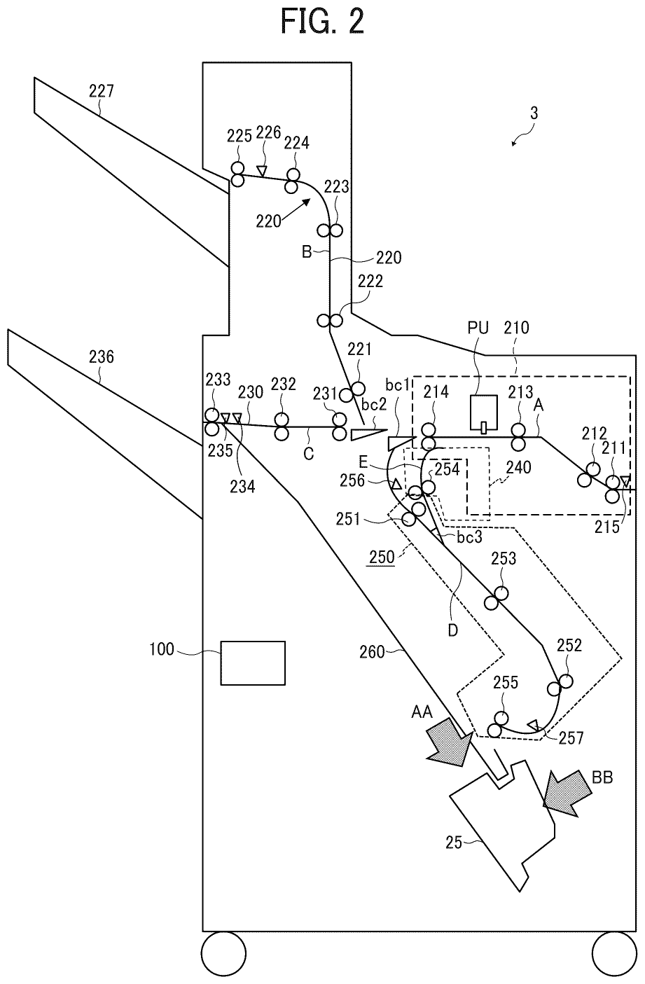

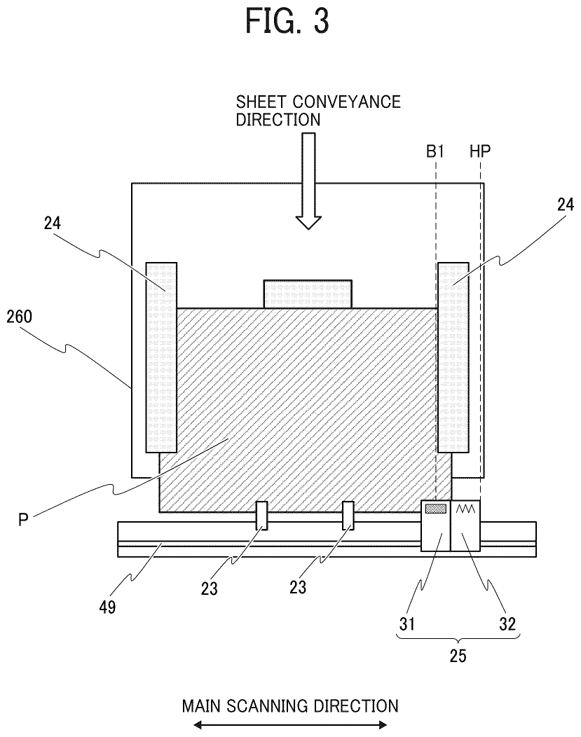

With reference to FIG. 3, a description is given below of the binder 25 as a binding device included in the post-processing apparatus 3 and the internal tray 260 on which sheets P are placed when the binder 25 performs binding on the sheets P. FIG. 3 is a schematic view of the binder 25 seen from the direction indicated by arrow BB in FIG. 2.

The sheet P is conveyed to the internal tray 260 by the internal-tray ejection roller pair 255. The white arrow illustrated in FIG. 3 indicates the conveyance direction of the sheet P in this specification. When the sheet P is ejected to the internal tray 260 after being conveyed by the internal-tray ejection roller pair 255, the sheet P slides down on an inclined placement surface of the internal tray 260 by gravity to reach the placement position. In the present specification, a direction indicated by a white arrow (a direction in which a sheet slides down on the placement surface and is stored) is defined as a conveyance direction.

When binding is performed on an end of the sheet bundle Pb in the binder 25, alignment processing for aligning the end of the sheet P or the sheet bundle Pb in the internal tray 260 is executed. As illustrated in FIG. 3, the internal tray 260 includes a pair of side fences 24 and end fences 23. The pair of side fences 24 define the positions of side ends of the sheet P or the sheet bundle Pb in order to perform the alignment processing. The end fences 23 define the position of a leading end of the sheet P conveyed toward the binder 25. The side fences 24 and the end fences 23 align ends of the sheets P or the sheet bundle Pb stacked on the internal tray 260, and a preparation for executing binding is performed.

The sheets P conveyed to the internal tray 260 are subjected to alignment in which the side ends of the sheets P are aligned by the side fences 24 and the leading ends of the sheets P conveyed toward the binder 25 are brought into contact with the end fence to be aligned along the end fence. Then, after the liquid application is performed on the last sheet Pe as the last medium of the sheet bundle Pb, the binding is performed. The binding is performed on a liquid application position that has been performed at a predetermined position in a direction orthogonal to the conveyance direction. The sheet bundle Pb subjected to the binding is ejected from the post-processing apparatus 3. The liquid application is performed for each sheet P for which the alignment has been completed.

As already described, the direction in which the sheet placed on the internal tray 260 heads for the end fence 23 is defined as a “conveyance direction” (sheet conveyance direction in FIG. 3). A direction that is orthogonal to the conveyance direction and a thickness direction of the sheet P is defined as a “main scanning direction” or a “width direction of the sheet P.”

FIG. 4 is a schematic view of the binder 25 viewed from an upstream side of the binder 25 in the conveyance direction (i.e., viewed from a direction indicated by arrow AA in FIG. 2). FIG. 5 is a schematic view of a liquid applier 31 of the binder 25 in the main scanning direction. As illustrated in FIG. 4, the binder 25 includes the liquid applier 31 and a crimper 32. The liquid applier 31 and the crimper 32 are disposed downstream from the internal tray 260 in the conveyance direction and adjacent to each other in the main scanning direction.

The liquid applier 31 applies liquid (for example, water) that is stored in a liquid storage tank 43 to the sheet P or the sheet bundle Pb placed on the internal tray 260. In the following description, the application of liquid may be referred to as “liquid application.”

More specifically, the liquid that is stored in the liquid storage tank 43 and used for the “liquid application” includes, as a main component, a liquid hydrogen-oxygen compound represented by the chemical formula H₂O. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid that is stored in a liquid storage tank 43 may include an additive in addition to the main component. The liquid that is stored in the liquid storage tank 43 may include residual chlorine used as tap water. Preferably, for example, the liquid that is stored in the liquid storage tank 43 may include, as an additive, a colorant, a penetrant, a pH adjuster, a preservative such as phenoxyethanol, a drying inhibitor such as glycerin, or a combination thereof. Since water is used as a component of ink used for inkjet printers or ink used for water-based pens, such water or ink may be used for the “liquid application.”

The water is not limited to the specific examples described above. The water may be water in a broad sense such as hypochlorous acid water or an ethanol aqueous solution diluted for disinfection. However, tap water may be used simply for the crimp binding because tap water is easy to obtain and store. A liquid including water as a main component as exemplified above enhances the binding strength of the sheet bundle Pb, as compared with a liquid of which the main component is not water.

The liquid applier 31 can be moved in the main scanning direction together with the crimper 32 by a driving force transmitted from the binder movement motor 50. A liquid application position to which the liquid is applied on the sheet P or the sheet bundle Pb by the liquid applier 31 corresponds to the binding position to be crimped and bound by the crimper 32.

For this reason, in the following description, the liquid application position and the binding position are denoted by the same reference numeral. As illustrated in FIGS. 4 and 5, the liquid applier 31 includes a lower pressure plate 33, an upper pressure plate 34 (presser), a liquid applier movement assembly 35, and a liquid application assembly 36. The components of the liquid applier 31 such as the lower pressure plate 33, the upper pressure plate 34, the liquid applier movement assembly 35, and the liquid application assembly 36 are held by the liquid application frame 31a and a base 48.

The lower pressure plate 33 and the upper pressure plate 34 are disposed downstream from the internal tray 260 in the conveyance direction. The lower pressure plate 33 supports, from below, the sheet P or the sheet bundle Pb placed on the internal tray 260. The lower pressure plate 33 is disposed on a lower-pressure-plate holder 331. The upper pressure plate 34 can move (up and down) in the thickness direction of the sheet P above the sheet P or the sheet bundle Pb placed on the internal tray 260. In other words, the lower pressure plate 33 and the upper pressure plate 34 are disposed to face each other in the thickness direction of the sheet P or the sheet bundle Pb with the sheet P or the sheet bundle Pb placed on the internal tray 260 and interposed between the lower pressure plate 33 and the upper pressure plate 34. In the following description, the thickness direction of the sheet P or the sheet bundle Pb may be referred to simply as “thickness direction.” The upper pressure plate 34 has a through hole 34a penetrating in the thickness direction at a position where the through hole 34a faces an end of a liquid application member 44 attached to a base plate 40.

The liquid applier movement assembly 35 moves the upper pressure plate 34, the base plate 40, and the liquid application member 44 in the thickness direction of the sheet P or the sheet bundle Pb. The liquid applier movement assembly 35 according to the present embodiment moves the upper pressure plate 34, the base plate 40, and the liquid application member 44 in conjunction with each other with a single liquid applier movement motor 37. The liquid applier movement assembly 35 includes, mainly, the liquid applier movement motor 37, a trapezoidal screw 38, a nut 39, the base plate 40, columns 41a and 41b, and coil springs 42a and 42b.

The liquid applier movement motor 37 generates a driving force to move the upper pressure plate 34, the base plate 40, and the liquid application member 44. Accordingly, controlling the driving of the liquid applier movement motor 37 can change the start position of the movement operation and the movement amount of the liquid application member 44.

The trapezoidal screw 38 extends in a vertical direction in FIGS. 3 and 4 and is rotatably supported by the liquid application frame 31a. The trapezoidal screw 38 is coupled to an output shaft of the liquid applier movement motor 37 via, for example, a pulley and a belt. The nut 39 is screwed to the trapezoidal screw 38. The trapezoidal screw 38 is rotated by the driving force transmitted from the liquid applier movement motor 37. The rotation of the trapezoidal screw 38 moves the nut 39.

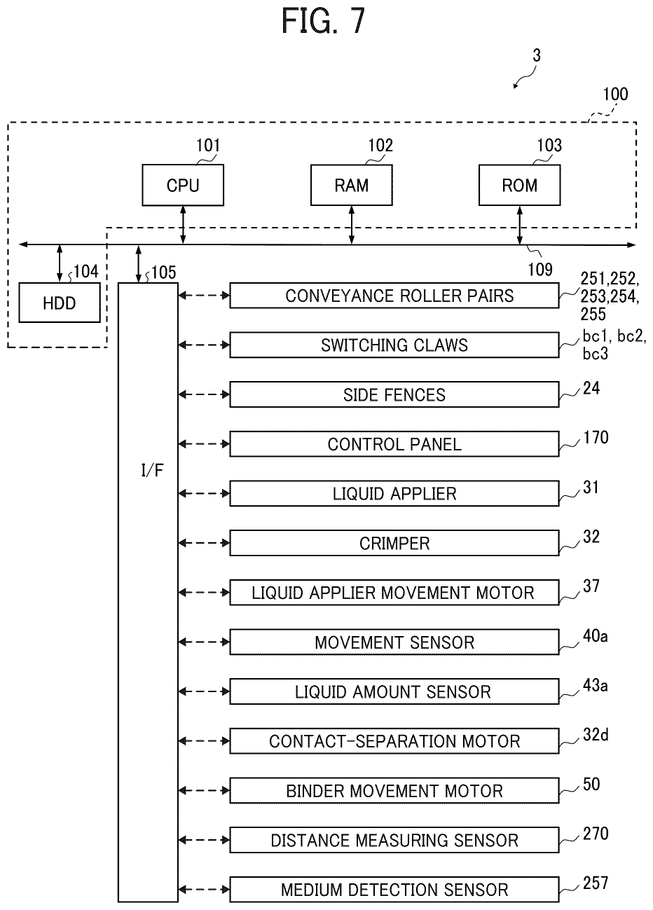

The base plate 40 is disposed above the upper pressure plate 34. The base plate 40 holds the liquid application member 44 with the end of the liquid application member 44 projecting downward. The base plate 40 is coupled to the trapezoidal screw 38 to move together with the trapezoidal screw 38. The position of the base plate 40 in the vertical direction is detected by a movement sensor 40a (see FIG. 7).

The columns 41a and 41b project downward from the base plate 40 around the end of the liquid application member 44. The columns 41a and 41b can move relative to the base plate 40 in the thickness direction. The columns 41a and 41b have respective lower ends holding the upper pressure plate 34. The columns 41a and 41b have respective upper ends provided with stoppers that prevent the columns 41a and 41b from being removed from the base plate 40. The coil springs 42a and 42b are fitted around the columns 41a and 41b, respectively, between the base plate 40 and the upper pressure plate 34. The coil springs 42a and 42b bias the upper pressure plate 34 and the columns 41a and 41b downward with respect to the base plate 40.

The moving amount of the liquid application member 44 is controlled by the liquid applier movement assembly 35 when the liquid application operation is performed on the sheet P. More specifically, when the liquid application member 44 descends toward the sheet P to perform the liquid application operation, the movement start position of the liquid application member 44 and the movement amount of the liquid application member 44 are controlled based on the distance between the upper surface of the sheet P and the contact surface of the liquid application member 44 during the liquid application. More specifically, the relative distance between the lower pressure plate 33 as a stage on which the sheet P is placed at a predetermined height position during the liquid application and the liquid application member 44 that descends toward the sheet P is controlled by the controller 100 that controls the operation of the liquid applier movement assembly 35. In the liquid applier movement assembly 35, the initial position of the liquid application member 44 is adjusted by the liquid applier movement motor 37.

The liquid application assembly 36 applies liquid to the sheet P or the sheet bundle Pb placed on the internal tray 260. Specifically, the liquid application assembly 36 brings the end of the liquid application member 44 into contact with the sheet P or the sheet bundle Pb to apply the liquid to at least one sheet P of the sheet bundle Pb. The liquid application assembly 36 includes the liquid storage tank 43, the liquid application member 44, a supplier 45, and a joint 46.

The liquid storage tank 43 stores the liquid to be supplied to the sheet P or the sheet bundle Pb. The amount of liquid that is stored in the liquid storage tank 43 is detected by a liquid amount sensor 43a. The liquid application member 44 supplies the liquid stored in the liquid storage tank 43 to the sheet P or the sheet bundle Pb. The liquid application member 44 is mounted on the base plate 40 with an end of the liquid application member 44 facing downward. The liquid application member 44 is made of a material having a relatively high liquid absorption e.g., sponge, fiber, or other material capable of absorbing and holding liquid).

The supplier 45 is an elongated member having a base end immersed in the liquid stored in the liquid storage tank 43 and another end coupled to the liquid application member 44. Like the liquid application member 44, for example, the supplier 45 is made of a material having a relatively high liquid absorption. Accordingly, the liquid absorbed from the base end of the supplier 45 is supplied to the liquid application member 44 by capillary action.

A protector 45a is an elongated cylindrical body (for example, a tube) that is fitted around the supplier 45. The protector 45a prevents the liquid absorbed by the supplier 45 from leaking or evaporating. Each of the supplier 45 and the protector 45a is made of a flexible material. The joint 46 fixes the liquid application member 44 to the base plate 40. Accordingly, the liquid application member 44 keeps projecting downward from the base plate 40 with the end of the liquid application member 44 facing downward when the liquid application member 44 is moved by the liquid applier movement assembly 35.

The crimper 32 presses and deforms the sheet bundle Pb with serrate binding teeth 32a and 32b to bind the sheet bundle Pb. In the following description, such a binding way may be referred to as “crimp binding.” In other words, the crimper 32 crimps and binds the sheet bundle Pb or performs the crimp binding on the sheet bundle Pb. In short, the crimper 32 binds the sheet bundle Pb without staples. The components of the crimper 32 such as the binding teeth 32a serving as upper crimping teeth and the binding teeth 32b serving as lower crimping teeth are disposed on a crimping frame 32c.

As described above, in the binder 25, the liquid applier 31 that applies liquid to the sheet P or the sheet bundle Pb receives liquid supplied from the liquid storage tank 43 to the liquid application member 44 which is a liquid absorber. The liquid application member 44 is moved by the liquid applier movement assembly 35 and is pressed against a target position (binding position B1) on the sheet P to apply a predetermined amount of liquid.

The amount by which the liquid application member 44 is pressed against the sheet P or the sheet bundle Pb, that is, the amount of movement by the liquid application assembly 36 including the liquid application member 44 can be adjusted to control the amount of compression of the liquid application member 44 as the liquid absorber. Controlling the compressing amount allows the amount of liquid applied to the sheet P to be adjusted to a predetermined amount.

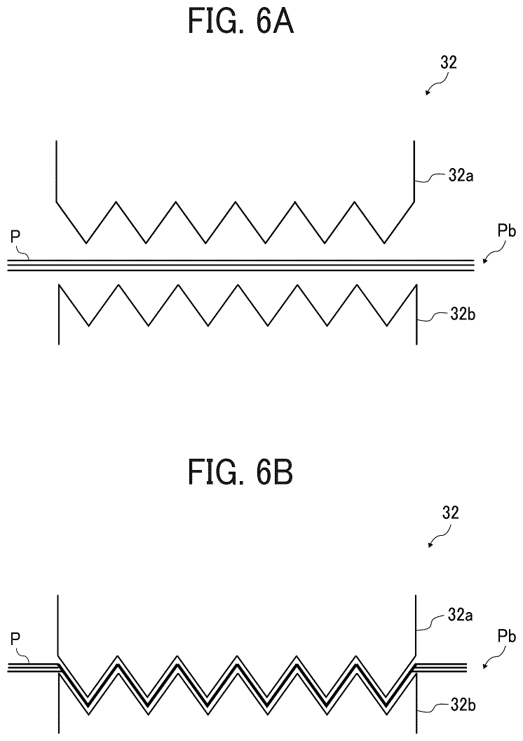

FIGS. 6A and 6B are schematic diagrams illustrating the configuration of the crimper 32. As illustrated in FIGS. 6A and 6B, the crimper 32 includes the pair of binding teeth 32a and 32b. The binding teeth 32a and the binding teeth 32b are disposed to face each other in the thickness direction of the sheet bundle Pb so that the binding teeth 32a and the binding teeth 32b can sandwich the sheet bundle Pb placed on the internal tray 260. The binding teeth 32a and the binding teeth 32b have respective serrate faces facing each other. The serrate face of each of the binding teeth 32a and the binding teeth 32b includes concave portions and convex portions alternately formed. The concave portions and the convex portions of the binding teeth 32a are shifted from those of the binding teeth 32b such that the binding teeth 32a are engaged with the binding teeth 32b. The binding teeth 32a and the binding teeth 32b are brought into contact with and separated from each other by a driving force of a contact-separation motor 32d illustrated in FIG. 7.

In a process in which the sheets P of the sheet bundle Pb are supplied to the internal tray 260, the binding teeth 32a and the binding teeth 32b are apart from each other as illustrated in FIG. 6A. When all the sheets P of the sheet bundle Pb are placed on the internal tray 260, the binding teeth 32a and the binding teeth 32b are engaged with each other to press and deform the sheet bundle Pb in the thickness direction as illustrated in FIG. 6B. As a result, the sheet bundle Pb that has been placed on the internal tray 260 is crimped and bound. The sheet bundle Pb thus crimped and bound is output to the lower shift tray 236 by the conveyance roller pairs.

The configuration of the crimper 32 as a crimping assembly is not limited to the configuration of the present embodiment provided that the binding teeth 32a and the binding teeth 32b of the crimping assembly are engaged with each other. The crimping assembly may be a crimping assembly disclosed in, for example, Japanese Patent No. 6057167. In this case, the crimping assembly brings the binding teeth 32a and the binding teeth 32b into contact with each other and separate the binding teeth 32a and the binding teeth 32b form each other with a link assembly and a driving source that simply rotates forward or that rotates forward and backward. Alternatively, the crimping assembly may employ a linear motion system to linearly bring the binding teeth 32a and the binding teeth 32b into contact with each other and separate the binding teeth 32a and the binding teeth 32b from each other with a screw assembly that converts the rotational motion of a driving source into linear motion.

As illustrated in FIG. 3, the binder 25 includes a binder movement assembly 47. The binder movement assembly 47 moves the binder 25 (in other words, the liquid applier 31 and the crimper 32) in the main scanning direction along the downstream end of the sheet P in the conveyance direction, which is placed on the internal tray 260. The binder movement assembly 47 includes, for example, the base 48, a guide shaft 49, a binder movement motor 50, and a driving force transmission assembly 51.

The liquid applier 31 and the crimper 32 are attached to the base 48 such that the liquid applier 31 and the crimper 32 are adjacent to each other in the main scanning direction. The guide shaft 49 extends in the main scanning direction at a position downstream from the internal tray 260 in the conveyance direction. The guide shaft 49 supports the base 48 such that the base 48 can move in the main scanning direction. The binder movement motor 50 generates a driving force to move the binder 25. The driving force transmission assembly 51 transmits the driving force of the binder movement motor 50 to the base 48 via a pulley and a timing belt. As a result, the liquid applier 31 and the crimper 32 integrated by the base 48 move in the main scanning direction along the guide shaft 49.

A description is given below of the control block of the post-processing apparatus 3. FIG. 7 is a block diagram illustrating a hardware configuration of the post-processing apparatus 3 to control an operation of the post-processing apparatus 3. As illustrated in FIG. 7, the post-processing apparatus 3 includes a central processing unit (CPU) 101, a random access memory (RAM) 102, a read only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, and the HDD 104 construct the controller 100 as a control block that controls the operation of the post-processing apparatus 3.

The I/F 105 is an interface that connects the conveyance roller pairs (e.g., the upstream conveyance roller pair 251, the downstream conveyance roller pair 252, the contact-separation conveyance roller pair 253, the retreat conveyance roller pair 254, and the internal-tray ejection roller pair 255), the branch claws (e.g., the branch claws bc1, bc2, and bc3), the side fences 24, the liquid applier 31, the crimper 32, the liquid applier movement motor 37, the contact-separation motor 32d, the binder movement motor 50, the movement sensor 40a, the liquid amount sensor 43a, the distance measuring sensor 270, the medium detection sensor 257, and the control panel 170 to the common bus 109. The controller 100 operates the conveyance roller pairs, the branching claws, the side fences 24, the liquid applier 31, the crimper 32, the liquid applier movement motor 37, the contact-separation motor 32d, and the binder movement motor 50 through the I/F 105, and acquires detection results from the movement sensor 40a, the liquid amount sensor 43a, the distance measuring sensor 270, and the medium detection sensor 257. FIG. 7 illustrates the components that execute the crimp binding and the liquid application.

As illustrated in FIG. 1, the image forming apparatus 2 includes the control panel 170. The control panel 170 includes an operating device that receives instructions input by a user and a display serving as a notifier that notifies the user of information. The operation unit as an input device includes, for example, hard keys and a touch screen overlaid on a display. The control panel 170 acquires information from the user through the operation unit and provides information to the user through the display. The user also inputs attribute information (e.g., size or thickness) of the sheet P via a user interface realized in the control panel 170, and the attribute information is held to be usable in the control program. Note that a specific example of the notifier is not limited to the display and may be a light emitting diode (LED) lamp or a speaker. The post-processing apparatus 3 may include the control panel 170 like the control panel 170 described above.

Below, a description is given of the relation between the number of sheets bound and liquid application.

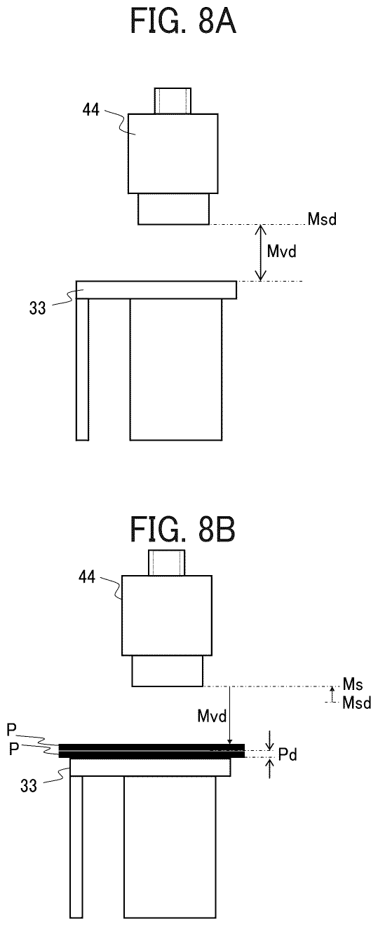

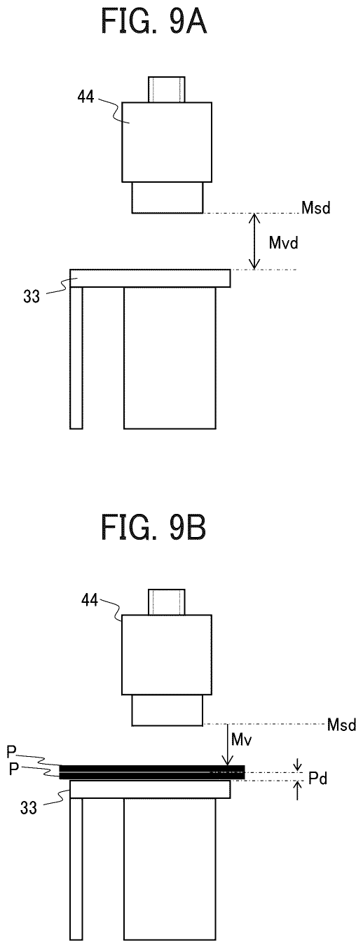

The moving operation of the liquid application member 44 is controlled to perform the liquid application on each sheet P with a predetermined liquid application amount. In such a case, when the number of sheets P in the sheet bundle Pb increases, the amount of the moving operation of the liquid application member 44 varies depending on the number of sheets P. The relation between the number of sheets P and the control amount of the liquid application member 44 is described below with reference to FIGS. 8A and 8B and 9A and 9B. As will be described below, when binding is executed, the liquid application member 44 is lowered toward and brought into contact with the sheet P in a state where the sheet P is placed on the lower pressure plate 33 included in the binder 25, and the liquid of the liquid application member 44 is applied to the sheet P. The liquid application amount at this time varies depending on the amount of contact between the liquid application member 44 and the sheet P.

The liquid application member 44 is made of a liquid-absorbing material. When the liquid application member 44 comes into contact with and is pressed against the sheet P, the liquid application member 44 is compressed to apply the retained liquid to the sheet P. Therefore, the “deformation amount” of the liquid application member 44 has a correlation with the liquid application amount. The “deformation amount” is based on the amount by which the liquid application member 44 is pressed against the sheet P. For this reason, even when the stack height of the sheets P increases, the start position of the operation is changed when the liquid application member 44 is lowered with respect to the sheets P (see FIGS. 8A and 8B) or the amount by which the liquid application member 44 is lowered is changed (see FIGS. 9A and 9B), in order to make the liquid application amount per sheet to the sheets P constant.

FIGS. 8A and 8B are diagrams illustrating a case where the lowering start position of the liquid application member 44 is changed. As illustrated in FIG. 8A, it is assumed that the position defined by a movement-start initial position Msd as an initial position corresponding to the distance between the contact surface of the liquid application member 44 with the sheet P and the placement surface of the lower pressure plate 33 is determined in advance. In addition, it is assumed that the operation amount defined by an initial movement amount Mvd as an initial movement amount, which corresponds to the movement amount of the liquid application member 44 until the liquid application member 44 reaches the placement surface of the lower pressure plate 33, is also determined in advance.

Then, the sheet P is placed on the placement surface of the lower pressure plate 33, and the displacement amount Pd per sheet is acquired from the thickness information of the sheet P. In this case, for example, as illustrated in FIG. 8B, the movement start position Ms when N sheets P are placed is determined by the following equation (1).

Movement start position Ms=movement-start initial position Msd+(displacement amount Pd per sheet P×n)(n: number of sheets P) . . . (1)

The lowering operation of the liquid application member 44 from the movement start position Ms calculated by the above-described equation (1) is performed based on the initial movement amount Mvd. Thus, the liquid application amount to each of the N sheets of sheet P in the sheet bundle Pb can be set to the predetermined liquid application amount.

FIGS. 9A and 9B are diagrams illustrating a case where the movement amount of the liquid application member 44 is changed. As illustrated in FIG. 9B, the movement amount Mv when N sheets P are placed is determined by the following equation (2).

Movement amount Mv=initial movement amount Mvd−(displacement amount Pd per sheet P×n)(n: number of sheets P) . . . (2)

The lowering operation of the liquid application member 44 based on the movement amount Mv calculated by the above equation (2) is performed from the position corresponding to the movement-start initial position Msd as the predetermined position of the movement start position. Thus, the liquid application amount to each of the N sheets P in the sheet bundle Pb can be set to the predetermined liquid application amount.

As described above, the start position from which the liquid application member 44 descends toward the sheet P or the sheet bundle Pb is changed or the movement amount by which the liquid application member 44 descends toward the sheet P or the sheet bundle Pb is changed according to the stacked state of the sheets P of the sheet bundle Pb. Changing the start position or the movement amount in the liquid application allows the deformation amount of the liquid application member 44 to be constant with respect to the sheet P or the uppermost sheet P of the sheet bundle Pb. As a result, the amount of liquid applied to each sheet P of the sheet bundle Pb can be kept constant.

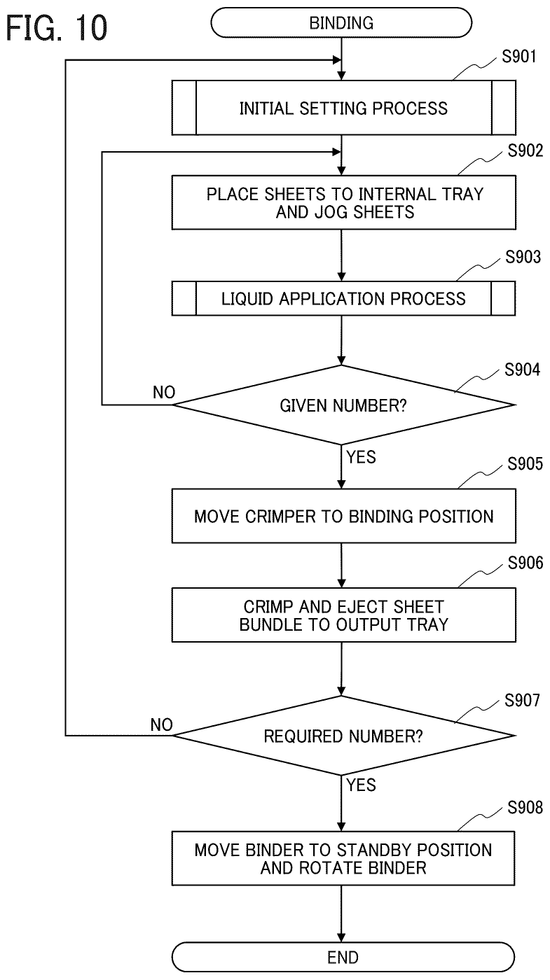

Next, a binding process executed in the medium processing apparatus according to an embodiment of the present disclosure is described with reference to the flowchart illustrated in FIG. 10. The binding process is executed by a binding control program executed in the controller 100. The following process is implemented by processing executed by the controller 100 in the binding control program First, the controller 100 executes an initial setting process of the liquid applier 31 (step S901). Details of the initial setting process are described later.

Next, in step S902, the controller 100 causes the conveyance roller pairs rotate to place a sheet P on which an image is formed by the image forming apparatus 2 in the internal tray 260. In step S902, the controller 100 also causes the side fences 24 to move to align the position of the sheet bundle Pb placed on the internal tray 260 in the main scanning direction. In short, the controller 100 performs so-called jogging.

In step S903, the controller 100 executes a liquid application process on the binding position B1 of the sheet P placed on the internal tray 260 in the immediately preceding step S902.

The details of the liquid application process is described later.

Subsequently, in step S904, the controller 100 determines whether the number of sheets P that are placed on the internal tray 260 has reached a given number N instructed by a binding command. The given number N of sheets corresponds to the number of sheets P in one sheet bundle Pb. When the controller 100 determines that the number of sheets P placed on the internal tray 260 has not reached the given number N of sheets (NO in step S904), the controller 100 executes the operations of steps S902 and S903 again.

In other words, the controller 100 executes the operations of steps S902 and 903 each time the sheet P is conveyed to the internal tray 260 by the conveyance roller pairs. However, depending on the processing content in step S903, liquid may not be applied to all the sheets P in the sheet bundle Pb. Then, separately from the liquid application determination process in step S903, the controller 100 may cause the liquid applier 31 to apply the liquid to the binding position B1 at intervals of one in every “n” sheets. Note that “n” is a natural number greater than 1 and less than “N” (i.e., 1<n<N).

When the controller 100 determines that the number of sheets P placed on the internal tray 260 reaches the given number N (YES in step S904), in step S905, the controller 100 drives the binder movement motor 50 to move the crimper 32 in the main scanning direction so that the crimper 32 faces the binding position B1.

In step S906, the controller 100 crimps and binds the sheet bundle Pb placed on the internal tray 260 and outputs the sheet bundle Pb to the lower shift tray 236. Specifically, the controller 100 drives the contact-separation motor 32d to cause the pair of binding teeth 32a and 32b to press the binding position B1 on the sheet bundle Pb placed on the internal tray 260 with the binding position B1 on the sheet bundle Pb sandwiched by the pair of binding teeth 32a and 32b. The controller 100 rotates the conveyance roller pair 233 to eject the sheet bundle Pb thus crimped and bound to the lower shift tray 236.

In step S907, the controller 100 determines whether the number of sheet bundles Pb ejected to the lower shift tray 236 has reached a predesignated required number of copies. If the number of copies is less than the required number (NO in step S907), the process returns to the step S901 and is repeatedly executed. If the required number of copies has been reached (YES in step S907), the controller 100 drives the binder movement motor 50 to move the crimper 32 to the standby position (step S908).

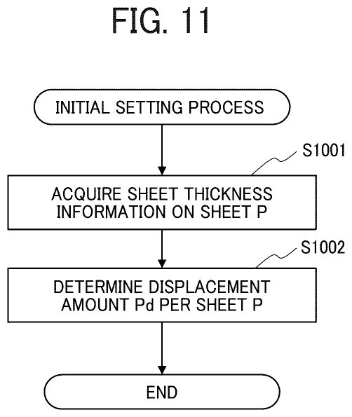

Below, a description is given of a first example of a liquid application process according to an embodiment of the present disclosure. First, details of the initial setting process (step S901) according to the first example are described with reference to the flowchart of FIG. 11. As illustrated in FIG. 11, in step S1001, the controller 100 acquires information (sheet thickness information d) relating to the thickness per sheet P. The sheet thickness information d may be a set value of a predetermined thickness included in the attribute information of the sheet P notified from the image forming apparatus 2 or may be a value set by the user. Alternatively, a sheet thickness sensor may be disposed on the conveyance path of the sheet P, and the sheet thickness information d may be a value detected by the sheet thickness sensor.

On the basis of the acquired sheet thickness information d, in step S1002, the controller 100 determines a displacement amount Pd by which the movement amount of the liquid application member 44 in the liquid application process is changed per sheet P. The determined displacement amount Pd is stored in a storage area included in the controller 100.

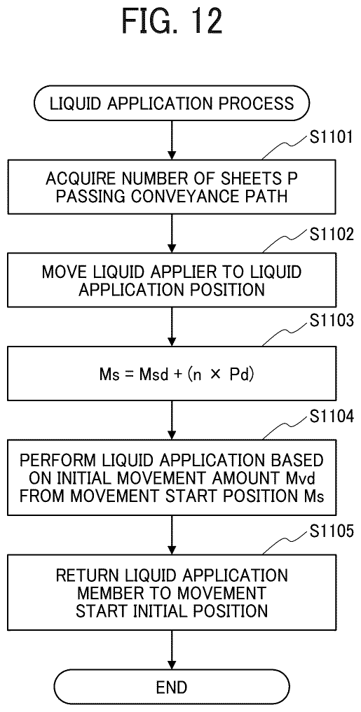

Subsequently, details of the liquid application process (step S903) according to the first example are described with reference to FIGS. 8A and 8B, which illustrates the case where the movement start position of the liquid application member 44 is changed, and the flowchart of FIG. 12. In step S1101, the controller 100 acquires, from the detection result of the medium detection sensor 257, the number of sheets P having passed the conveyance path (i.e., number n of passage of sheets).

Subsequently, the controller 100 drives the binder movement motor 50 to move the binder 25 in the main scanning direction from a standby position HP toward the liquid application position B1 (corresponding to the binding position B1) so that the liquid applier 31 faces the liquid application position B1 as illustrated in FIG. 3 (step S1102).

Subsequently, the controller 100 acquires the displacement amount Pd stored in the storage area, and determines the movement start position Ms of the liquid application member 44 in the liquid application operation by the above-described equation (1) (step S1103).

In other words, the controller 100 adds a value obtained by multiplying the “displacement amount Pd per sheet of sheet P (displacement amount by which the movement amount of the liquid application member 44 is displaced based on the sheet thickness information d)” and the “number n of sheets P (i.e., number n of passage of sheets)” to the “movement-start initial position Msd”, to determine the movement start position Ms. Subsequently, as illustrated in FIG. 8B, the controller 100 causes the liquid application member 44 to move to the movement start position Ms calculated by the above-described equation (1), move from the movement start position Ms toward the sheet P or the sheet bundle Pb based on the initial movement amount Mvd, and perform the liquid application on the sheet P (step S1104). When the liquid application on the sheet Pends, in step S1105, the controller 100 causes the liquid application member 44 to move to the movement-start initial position Msd.

As described above, in the process of forming the sheet bundle Pb, the position at which the liquid application member 44 starts to move toward the sheet P or the sheet bundle Pb can be changed in accordance with the change in the position of the uppermost surface of the sheet P or the sheet bundle Pb. As a result, the amount of deformation of the liquid application member 44 with respect to the uppermost surface of the sheet P or the sheet bundle Pb can be made constant, so that the amount of liquid applied to each sheet P of the sheet bundle Pb can be made constant.

Next, a description is given of a second example of a liquid application process according to an embodiment of the present disclosure. Since details of the initial setting process (step S901) according to the second example are similar to, even if not the same as, those of the first example, detailed descriptions thereof are omitted below (see FIG. 11).

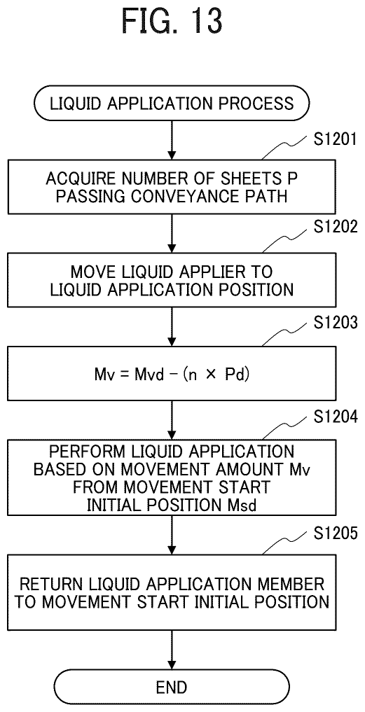

Subsequently, details of the liquid application process (step S903) according to the second example are described with reference to FIGS. 9A and 9B, which illustrate the case where the movement start position of the liquid application member 44 is changed, and the flowchart of FIG. 13. In step S1201, the controller 100 acquires, from the detection result of the medium detection sensor 257, the number of sheets P having passed the conveyance path (i.e., number n of passage of sheets).

Subsequently, the controller 100 drives the binder movement motor 50 to move the binder 25 in the main scanning direction from a standby position HP toward the liquid application position B1 (corresponding to the binding position B1) so that the liquid applier 31 faces the liquid application position B1 as illustrated in FIG. 3 (step S1202).

Subsequently, the controller 100 acquires the displacement amount Pd stored in the storage area, and determines a movement amount Mv of the liquid application member 44 in the liquid application operation by the above-described equation (2) (step S1203).

In other words, the controller 100 adds a value obtained by multiplying the “displacement amount Pd per sheet of sheet P (displacement amount by which the movement amount of the liquid application member 44 is displaced based on the sheet thickness information d)” and the “number n of sheets P (i.e., number n of passage of sheets)” to the “initial movement amount Mvd”, to determine the movement amount Mv.

Subsequently, as illustrated in FIG. 9B, the controller 100 causes the liquid application member 44 to move from the movement-start initial position Msd toward the sheet P or the sheet bundle Pb on the basis of the movement amount Mv calculated by the above-described equation (2), and perform the liquid application on the sheet P (step S1204). When the liquid application on the sheet P ends, in step S1205, the controller 100 causes the liquid application member 44 to move to the movement-start initial position Msd.

As described above, in the process of forming the sheet bundle Pb, the movement amount by which the liquid application member 44 moves toward the sheet P or the sheet bundle Pb can be changed in accordance with the change in the position of the uppermost surface of the sheet P or the sheet bundle Pb. As a result, the amount of deformation of the liquid application member 44 with respect to the uppermost surface of the sheet P or the sheet bundle Pb can be made constant, so that the amount of liquid applied to each sheet P of the sheet bundle Pb can be made constant.

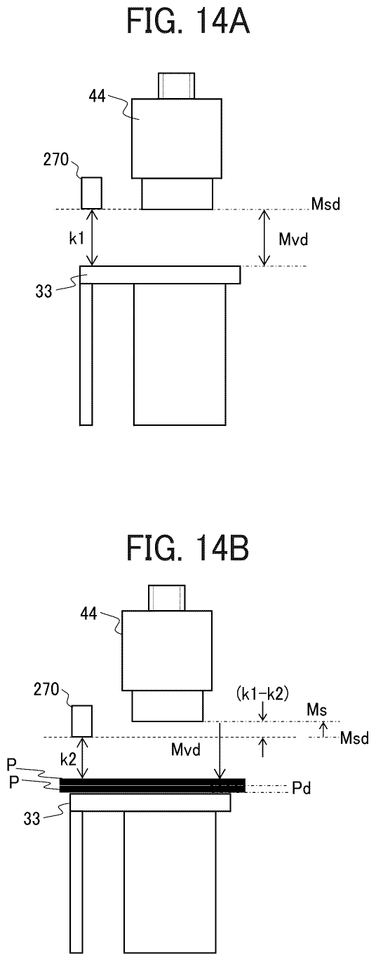

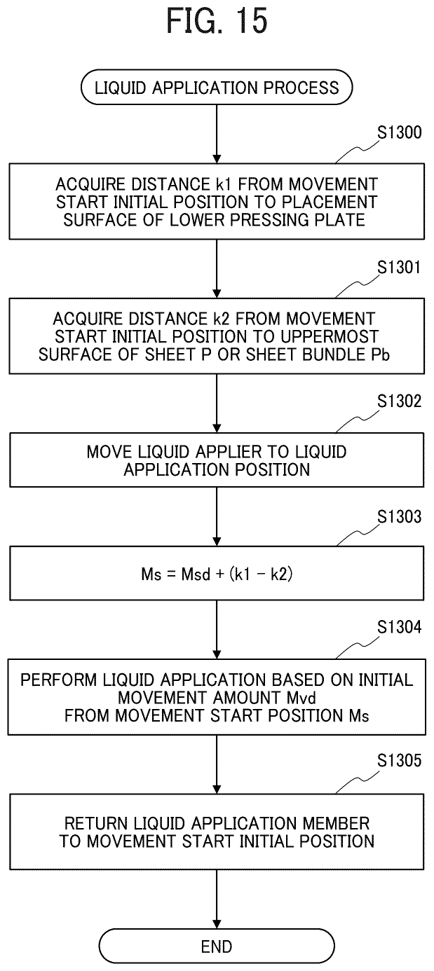

Next, a description is given of a third example of a liquid application process according to an embodiment of the present disclosure. Subsequently, details of the liquid application process (step S903) according to the third example are described with reference to FIGS. 14A and 14B, which illustrate a case where the movement start position of the liquid application member 44 is changed, and the flowchart of FIG. 15.

As illustrated in FIG. 14A, in step S1300, the controller 100 acquires a distance k1 from the movement-start initial position Msd to the placement surface of the lower pressure plate 33 on the basis of the output of the distance measuring sensor 270 in a state where the sheet P and the sheet bundle Pb are not placed on the internal tray 260 (in a state where the sheet P and the sheet bundle Pb are not placed on the lower pressure plate 33).

As illustrated in FIG. 14B, every time a sheet P is placed on the internal tray 260 (every time a sheet P is placed on the lower pressure plate 33), the controller 100 acquires a distance k2 from the movement-start initial position Msd to the uppermost surface of the sheet P or the sheet bundle Pb on the basis of the output of the distance measuring sensor 270 (step S1301).

The distance k1 and the distance k2 described above are information used to calculate a control amount for operating the liquid application member 44 described below. More specifically, the distance k1 and the distance k2 are information used for controlling the liquid application member 44 to contact the uppermost surface of the sheet P or the sheet bundle Pb with a specific deformation amount, and are also information for specifying a relative interval between the uppermost surface of the sheet P or the sheet bundle Pb and the contact surface of the liquid application member 44. For this reason, an output from another sensor or a configuration capable of outputting the information based on image analysis may be used, instead of using the output of the distance measuring sensor 270.

In step S1302, the controller 100 drives the binder movement motor 50 to move the binder 25 in the main scanning direction from a standby position HP toward the liquid application position B1 (corresponding to the binding position B1) so that the liquid applier 31 faces the liquid application position B1 as illustrated in FIG. 3.

In step S1303, the controller 100 uses the acquired distance kl and distance k2 to determine the movement start position Ms of the liquid application member 44 in the liquid application operation according to the following equation (3).

Movement start position Ms=movement-start initial position Msd+(distance k1 from movement-start initial position to placement surface of lower pressure plate 33−distance k2 from movement-start initial position to uppermost surface of sheet P or sheet bundle Pb) . . . (3)

Subsequently, as illustrated in FIG. 14B, the controller 100 causes the liquid application member 44 to move to the movement start position Ms calculated by the above-described equation (3), move from the movement start position Ms toward the sheet P or the sheet bundle Pb based on the initial movement amount Mvd, and perform the liquid application on the sheet P (step S1304). When the liquid application on the sheet P ends, as illustrated in FIG. 14A, the controller 100 causes the liquid application member 44 to move to the movement-start initial position Msd (step S1305).

As described above, in the process of forming the sheet bundle Pb, the position at which the liquid application member 44 starts to move toward the sheet P or the sheet bundle Pb can be changed in accordance with the change in the position of the uppermost surface of the sheet P or the sheet bundle Pb. As a result, the amount of deformation of the liquid application member 44 with respect to the uppermost surface of the sheet P or the sheet bundle Pb can be made constant, so that the amount of liquid applied to each sheet P of the sheet bundle Pb can be made constant.

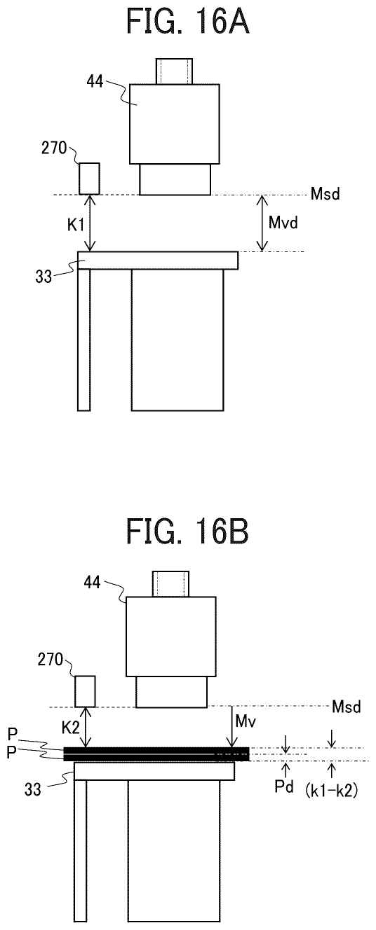

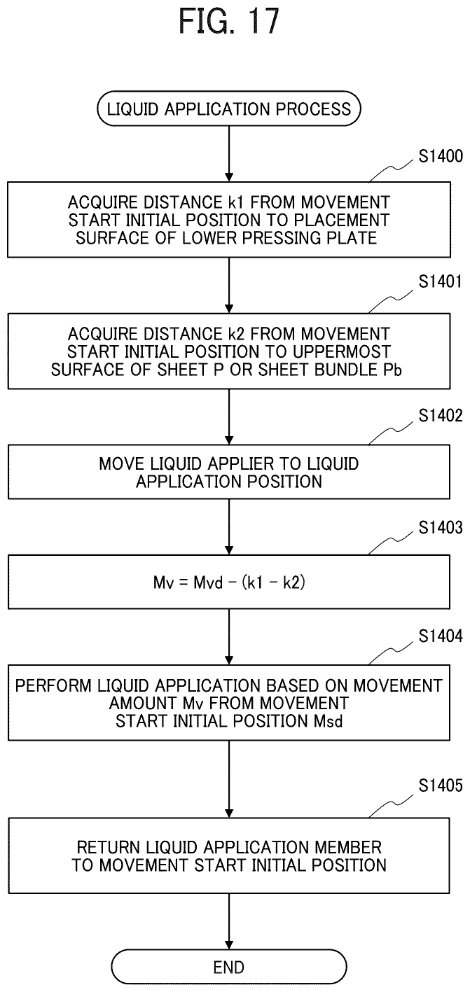

Next, a description is given of a fourth example of a liquid application process according to an embodiment of the present disclosure. Details of the liquid application process (step S903) according to the fourth example are described with reference to FIGS. 16A and 16B, which illustrate a case where the movement amount of the liquid application member 44 is changed, and the flowchart of FIG. 17. As illustrated in FIG. 16A, in step S1400, the controller 100 acquires a distance k1 from the movement-start initial position Msd to the placement surface of the lower pressure plate 33 on the basis of the output of the distance measuring sensor 270 in a state where the sheet P and the sheet bundle Pb are not placed on the internal tray 260 (in a state where the sheet P and the sheet bundle Pb are not placed on the lower pressure plate 33). As illustrated in FIG. 16B, every time a sheet P is placed on the internal tray 260 (every time a sheet P is placed on the lower pressure plate 33), the controller 100 acquires a distance k2 from the movement-start initial position Msd to the uppermost surface of the sheet P or the sheet bundle Pb on the basis of the output of the distance measuring sensor 270 (step S1401). Also in the step S1401, similarly to the step S1301, a configuration other than the distance measuring sensor 270 and capable of acquiring information specifying the relative distance between the uppermost surface of the sheet P or the sheet bundle Pb and the contact surface of the liquid application member 44 may be used.

In step S1402, the controller 100 drives the binder movement motor 50 to move the binder 25 from a standby position HP toward the liquid application position B1 (corresponding to the binding position B1) so that the liquid applier 31 faces the liquid application position B1 as illustrated in FIG. 3.

In step S1403, the controller 100 uses the acquired distance k1 and distance k2 to determine the movement amount Mv of the liquid application member 44 in the liquid application operation according to the following equation (4).

Movement amount Mv=initial movement amount Mvd−(distance k1 from movement-start initial position to placement surface of lower pressure plate 33−distance k2 from movement-start initial position to uppermost surface of sheet P or sheet bundle Pb) . . . (4)

Subsequently, as illustrated in FIG. 16B, the controller 100 causes the liquid application member 44 to move from the movement-start initial position Msd toward the sheet P or the sheet bundle Pb on the basis of the movement amount Mv calculated by the above-described equation (4), and perform the liquid application on the sheet P (step S1404). When the liquid application on the sheet P ends, as illustrated in FIG. 16A, the controller 100 causes the liquid application member 44 to move to the movement-start initial position Msd (step S1405).

As described above, in the process of forming the sheet bundle Pb, the movement amount by which the liquid application member 44 moves toward the sheet P or the sheet bundle Pb can be changed in accordance with the change in the position of the uppermost surface of the sheet P or the sheet bundle Pb. As a result, the amount of deformation of the liquid application member 44 with respect to the uppermost surface of the sheet P or the sheet bundle Pb can be made constant, so that the amount of liquid applied to each sheet P of the sheet bundle Pb can be made constant.

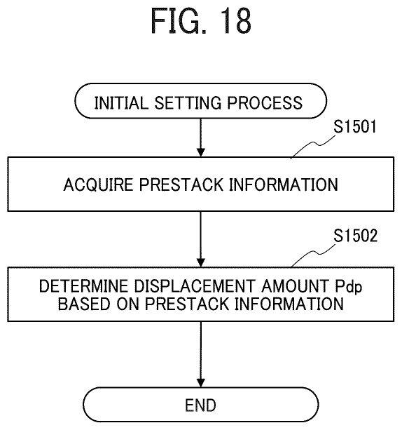

Below, a description is given of a fifth example of a liquid application process according to an embodiment of the present disclosure. First, details of the initial setting process (step S901) according to the fifth example are described with reference to the flowchart of FIG. 18. As illustrated in FIG. 18, in step S1501, the controller 100 acquires prestack information. The prestack information is notified from the image forming apparatus 2 and is the number of sheets P to be subjected to prestacking in the retreat conveyance path E. The prestack information includes the number of sheets P that are conveyed in an overlaid manner before the liquid application. When the prestacking is performed, liquid can be applied only to the uppermost sheet P of the sheet bundle Pb on the internal tray 260. In this case, since a desired binding force is not obtained with the liquid application amount for one sheet of the sheets P, control is performed to increase the liquid application amount for one time.

For this reason, on the basis of the acquired prestack information, the controller 100 determines a prestack adjustment amount Pdp for adjusting the movement amount of the liquid application member 44 toward the sheet P or the sheet bundle Pb in the liquid application for each sheet of the sheets P (step S1502). The determined pre-stack adjustment amount Pdp is stored in a storage area included in the controller 100.

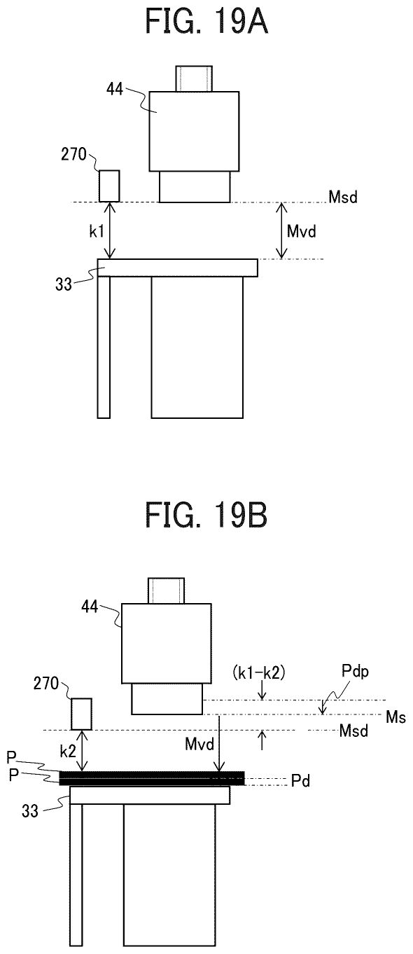

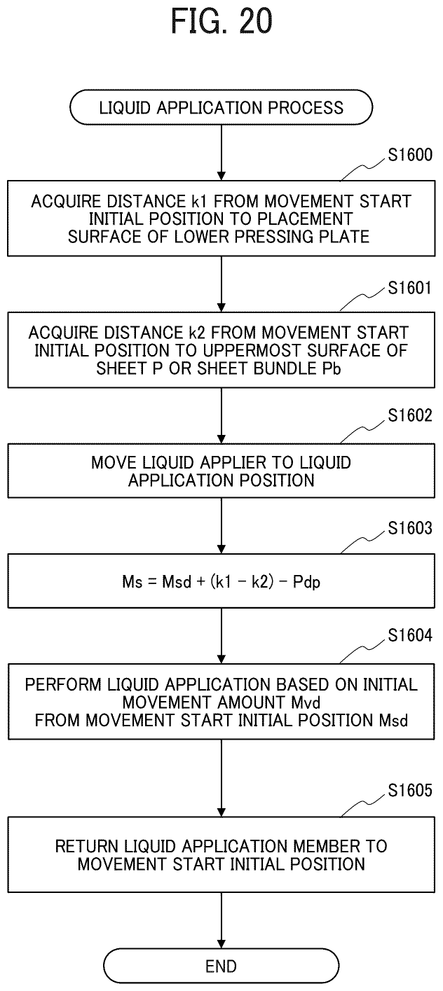

Subsequently, details of the liquid application process (step S903) according to the fifth example are described with reference to FIGS. 19A and 19B, which illustrate a case where the movement start position of the liquid application member 44 is changed, and the flowchart of FIG. 20.

As illustrated in FIG. 19A, in step S1600, the controller 100 acquires a distance k1 from the movement-start initial position Msd to the placement surface of the lower pressure plate 33 on the basis of the output of the distance measuring sensor 270 in a state where the sheet P and the sheet bundle Pb are not placed on the internal tray 260 (in a state where the sheet P and the sheet bundle Pb are not placed on the lower pressure plate 33). As illustrated in FIG. 19B, every time a sheet P is placed on the internal tray 260 (every time a sheet P is placed on the lower pressure plate 33), the controller 100 acquires a distance k2 from the movement-start initial position Msd to the uppermost surface of the sheet P or the sheet bundle Pb on the basis of the output of the distance measuring sensor 270 (step S1601).

In step S1602, the controller 100 drives the binder movement motor 50 to move the binder 25 in the main scanning direction from a standby position HP toward the liquid application position B1 (corresponding to the binding position B1) so that the liquid applier 31 faces the liquid application position B1 as illustrated in FIG. 3.

In step S1603, the controller 100 uses the acquired distance k1 and distance k2 and the prestack adjustment amount Pdp to determine the movement start position Ms of the liquid application member 44 in the liquid application operation according to the following equation (5).

Movement start position Ms=movement-start initial position Msd+(distance k1 from movement-start initial position to placement surface of lower pressure plate 33−distance k2 from movement-start initial position to uppermost surface of the sheet P or sheet bundle Pb)−(adjustment amount Pdp for adjusting movement amount of liquid application member 44 based on prestack information) . . . (5)

Subsequently, as illustrated in FIG. 19B, the controller 100 causes the liquid application member 44 to move to the movement start position Ms calculated by the above-described equation (5), move from the movement start position Ms toward the sheet P or the sheet bundle Pb based on the initial movement amount Mvd, and perform the liquid application on the sheet P (step S1604). When the liquid application on the sheet P ends, as illustrated in FIG. 19A, the controller 100 causes the liquid application member 44 to move to the movement-start initial position Msd (step S1605).

As described above, in the process of forming the sheet bundle Pb, the movement amount by which the liquid application member 44 moves toward the sheet P or the sheet bundle Pb can be changed in accordance with the change in the position of the uppermost surface of the sheet P or the sheet bundle Pb. As a result, the amount of deformation of the liquid application member 44 with respect to the uppermost surface of the sheet P or the sheet bundle Pb can be made constant, so that the amount of liquid applied to each sheet P of the sheet bundle Pb can be made constant.

Next, a description is given of a sixth example of a liquid application process according to an embodiment of the present disclosure. Since details of the initial setting process (step S901) according to the sixth example are similar to, even if not the same as, those of the fifth example, detailed descriptions thereof are omitted below (see FIG. 11). Details of the liquid application process (step S903) according to the sixth example are described with reference to

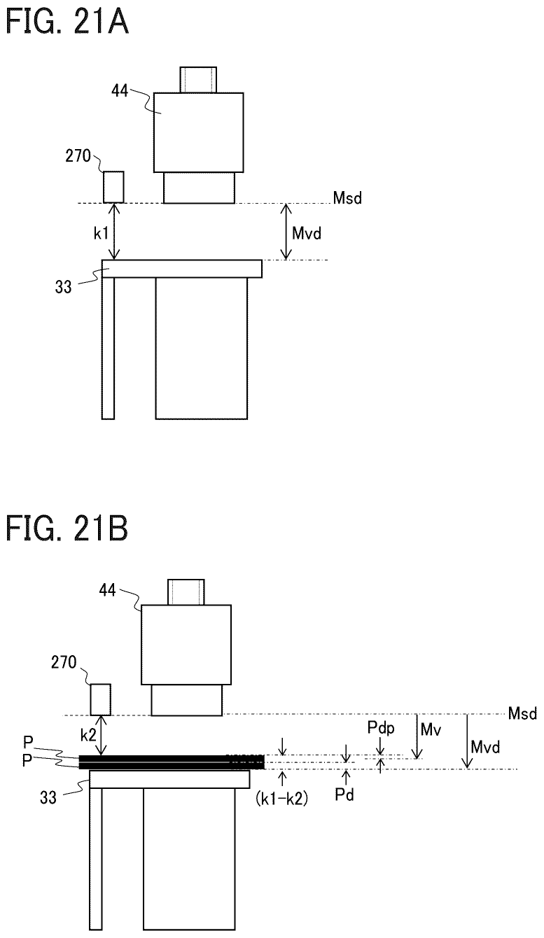

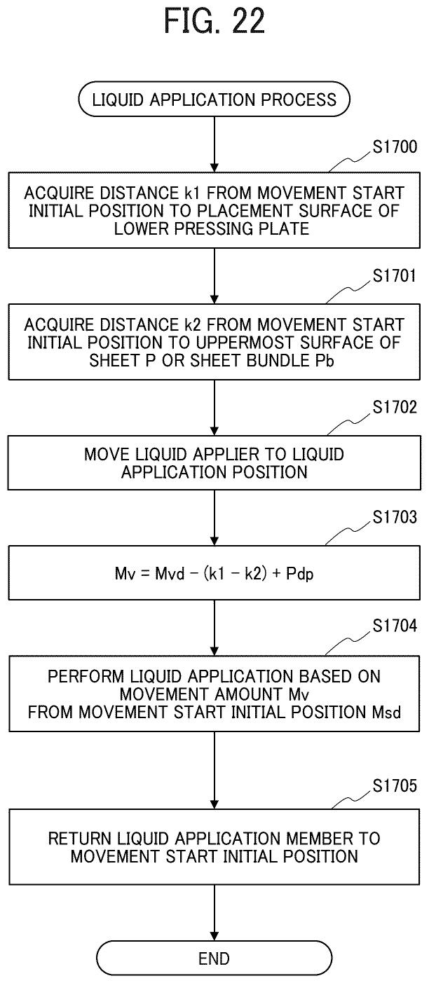

FIGS. 21A and 21B, which illustrate a case where the movement amount of the liquid application member 44 is changed, and the flowchart of FIG. 22.

As illustrated in FIG. 21A, in step S1700, the controller 100 acquires a distance k1 from the movement-start initial position Msd to the placement surface of the internal tray 260 on the basis of the output of the distance measuring sensor 270 in a state where the sheet P and the sheet bundle Pb are not placed on the internal tray 260 (in a state where the sheet P and the sheet bundle Pb are not placed on the lower pressure plate 33). As illustrated in FIG. 21B, every time a sheet P is placed on the internal tray 260 (every time a sheet P is placed on the lower pressure plate 33), the controller 100 acquires a distance k2 from the movement-start initial position Msd to the uppermost surface of the sheet P or the sheet bundle Pb on the basis of the output of the distance measuring sensor 270 (step S1701).

In step S1702, the controller 100 drives the binder movement motor 50 to move the binder 25 in the main scanning direction from a standby position HP toward the liquid application position B1 (corresponding to the binding position B1) so that the liquid applier 31 faces the liquid application position B1 as illustrated in FIG. 3.

In step S1703, the controller 100 uses the acquired distance k1 and distance k2 and the prestack adjustment amount Pdp to determine the movement amount Mv of the liquid application member 44 in the liquid application operation according to the following equation (6).

Movement amount Mv=initial movement amount Mvd−(distance k1 from movement-start initial position to placement surface of lower pressure plate 33−distance k2 from movement-start initial position to uppermost surface of sheet P or sheet bundle Pb)+(adjustment amount Pdp for adjusting movement amount of liquid application member 44 based on prestack information) . . . (6)

Subsequently, as illustrated in FIG. 21B, the controller 100 causes the liquid application member 44 to move from the movement-start initial position Msd toward the sheet P or the sheet bundle Pb on the basis of the movement amount Mv calculated by the above-described equation (6), and perform the liquid application on the sheet P (step S1704). When the liquid application on the sheet P ends, as illustrated in FIG. 21A, the controller 100 causes the liquid application member 44 to move to the movement-start initial position Msd (step S1705).

As described above, in the process of forming the sheet bundle Pb, the movement amount by which the liquid application member 44 moves toward the sheet P or the sheet bundle Pb can be changed in accordance with the change in the position of the uppermost surface of the sheet P or the sheet bundle Pb. As a result, the amount of deformation of the liquid application member 44 with respect to the uppermost surface of the sheet P or the sheet bundle Pb can be made constant, so that the amount of liquid applied to each sheet P of the sheet bundle Pb can be made constant.

As sheets P are stacked and the number of sheets P increases, the relative positions (interval) between the liquid application member 44 and the sheet P or the uppermost sheet P of the sheet bundle Pb change. Even in such cases, the above-described process can prevent the liquid application amount of the liquid application member 44 with respect to the sheet P from shifting from an appropriate amount. That is, depending on the number of sheets P in the sheet bundle Pb, the start position of liquid application of the liquid application member 44 is changed while the movement amount of lowering the liquid application member 44 in liquid application is kept at a predetermined value, or the movement amount of lowering the liquid application member 44 in liquid application is changed without changing the start position of liquid application of the liquid application member 44. Thus, the amount by which the liquid application member 44 is pressed against the sheet P is made constant. As a result, the amount of liquid applied to the sheet P by the liquid application member 44 can be maintained constant.

In the above description, the number of sheets P in the sheet bundle Pb is calculated based on the detection result of the medium detection sensor 257. In some embodiments, the number of sheets P may be calculated on the basis of the number of sheets per bundle notified from the image forming apparatus 2 in conjunction with the sheet bundle Pb.

According to the above-described embodiment, the following operational effects, for example, can be achieved. That is, when the post-processing apparatus 3 performs the crimp binding, the liquid application amount using the liquid application member 44 can be set to a predetermined value. Therefore, the operation start position or the operation amount of the liquid application member 44 is changed in accordance with the thickness of the sheet bundle Pb stacked in the internal tray 260.

When the operation start position of the liquid application member 44 is changed in accordance with the height of the sheet bundle Pb, the movement amount as the operation amount is set to a predetermined value.

When the operation start position of the liquid application member 44 is not changed, the movement amount as the operation amount is changed in accordance with the height of the sheet bundle Pb.

The operation start position and the operation amount are appropriately changed so that the liquid application amount takes an appropriate value with respect to the sheet P which has been subjected to the prestacking and conveyed.

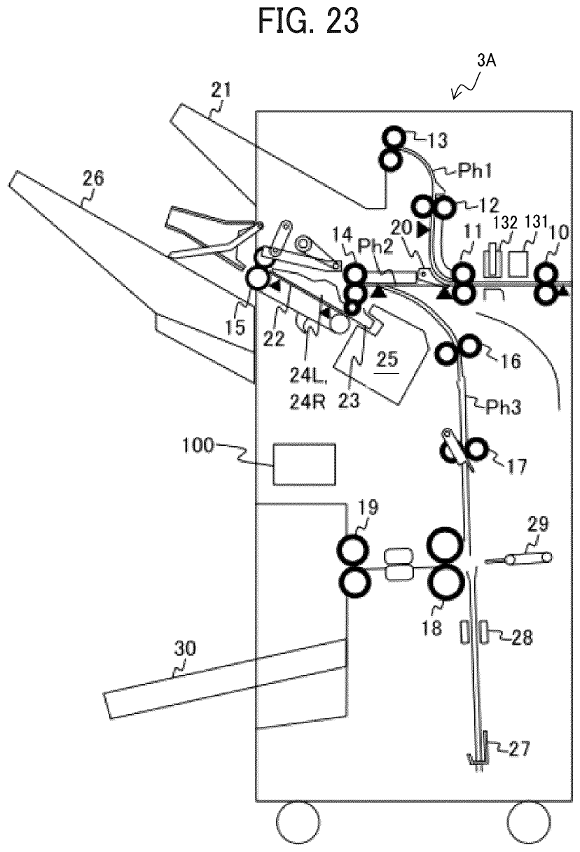

Now, a description is given of a second embodiment of the present disclosure. Specifically, with reference to FIGS. 23 to 31, a description is now given of a post-processing apparatus 3A according to the second embodiment of the present disclosure. In the following description, components like those of the first embodiment are denoted by like reference numerals, and redundant descriptions thereof may be omitted.

The post-processing apparatus 3A according to the second embodiment is different from the post-processing apparatus 3 according to the first embodiment in which the liquid applier 31 and the crimper 32 are arranged side by side. In the post-processing apparatus 3A according to the second embodiment, a liquid applier 131 is disposed alone at an upstream position in a direction in which the sheet P is conveyed. Such a configuration allows a given number of sheets P to be stacked after the liquid is applied and conveyed to the crimper 32 of the binder 25 disposed at a downstream position in the direction in which the sheet P is conveyed. Accordingly, the productivity of the binding process performed by the crimper 32 is enhanced. Since the direction in which the conveyance roller pairs 10, 11, and 14 convey the sheet P is opposite to the “conveyance direction” defined above, the direction in which the conveyance roller pairs 10, 11, and 14 convey the sheet P is defined as an “opposite conveyance direction” in the following description. A direction that is orthogonal to the opposite conveyance direction and the thickness direction of the sheet P is defined as the “main scanning direction” or the “width direction of the sheet P.”

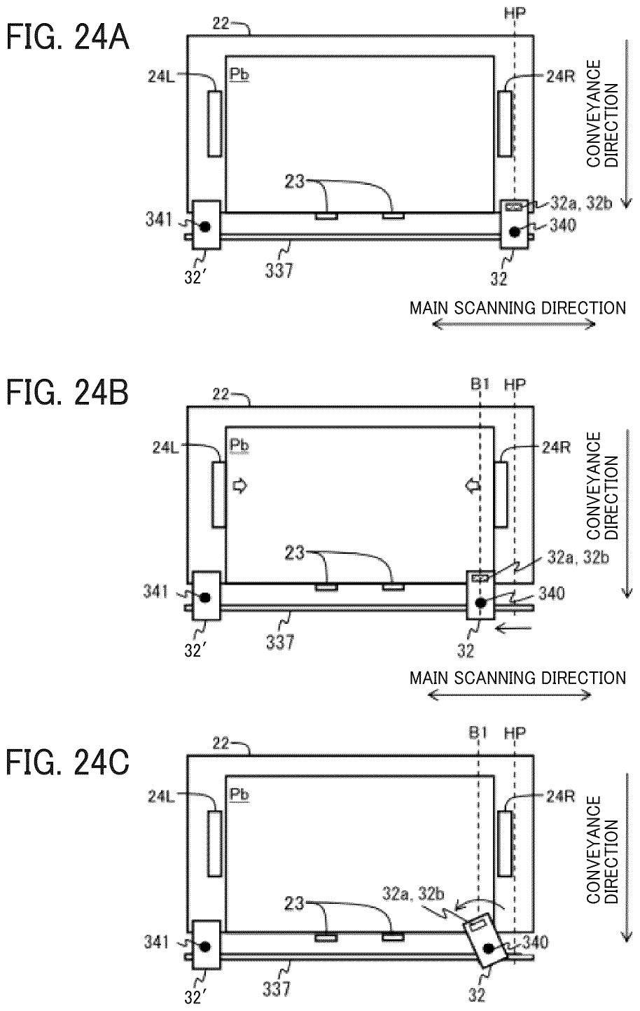

FIG. 23 is a diagram illustrating an internal configuration of the post-processing apparatus 3A according to the second embodiment of the present disclosure. As illustrated in FIGS. 24A to 24C, the binder 25 includes the crimper 32 and a stapler 32′. As illustrated in FIGS. 23A to 23C, the crimper 32 and the stapler 32′ are disposed downstream from the internal tray 22 in the conveyance direction. In addition, the crimper 32 and the stapler 32′ are located to face a downstream end, in the conveyance direction, of the sheet bundle Pb placed on the internal tray 22 and move in the main scanning direction. Further, the crimper 32 and the stapler 32′ are pivoted about an axis extending in the thickness direction of the sheet bundle Pb placed on the internal tray 22. In other words, the crimper 32 and the stapler 32′ bind, at a desired angle, a desired position in the main scanning direction on the sheet bundle Pb placed on the internal tray 22 in, for example, corner oblique binding, parallel one-point binding, or parallel two-point binding.

The crimper 32 presses and deforms the sheet bundle Pb with serrate binding teeth 32a and 32b to bind the sheet bundle Pb. In the following description, such a binding way may be referred to as “crimp binding.” In other words, the crimper 32 crimps and binds the sheet bundle Pb or performs the crimp binding on the sheet bundle Pb. On the other hand, the stapler 32′ passes the staple through a binding position on the sheet bundle Pb placed on the internal tray 22 to staple the sheet bundle Pb.

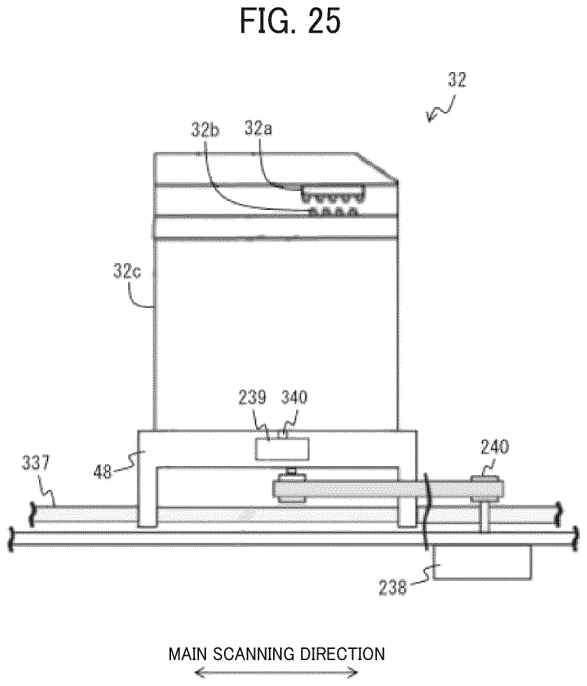

Each of FIGS. 24A to 24C is a view of the internal tray 22 in the thickness direction of the sheet bundle Pb. FIG. 25 is a schematic view of an upstream side of the crimper 32 in the conveyance direction. As illustrated in FIGS. 24A to 24C, the crimper 32 and the stapler 32′ are disposed downstream from the internal tray 22 in the conveyance direction. The crimper 32 moves in the main scanning direction along the surface of the sheet bundle Pb placed on the internal tray 22. The crimper 32 is also pivoted about a pivot 340 extending in the thickness direction of the sheet bundle Pb placed on the internal tray 22. Similarly, the stapler 32′ moves in the main scanning direction of the sheet bundle Pb and is pivoted about a pivot 341 extending in the thickness direction of the sheet bundle Pb.

More specifically, as illustrated in FIG. 25, a guide rail 337 extending in the main scanning direction is disposed downstream from the internal tray 22 in the conveyance direction. The crimper 32 is moved in the main scanning direction along the surface of the sheet bundle Pb placed on the internal tray 22, in other words, along the guide rail 337, by a driving force transmitted from a crimper movement motor 238 by a drive transmission assembly 240 including a pulley and a timing belt. The pivot 340 is fixed to a bottom face of the crimping frame 32c that holds the components of the crimper 32. The pivot 340 is rotatably held by the base 48 on which the crimping frame 32c is disposed. When a driving force is transmitted from a pivot motor 239 to the pivot 340, the crimper 32 is pivoted about the pivot 340 extending in the thickness direction of the sheet P placed on the internal tray 22. The guide rail 337, the crimper movement motor 238, the pivot motor 239, the pivot 340, and the drive transmission assembly 240 construct a driving assembly of the crimper 32.

The crimper 32 moves between the standby position HP illustrated in FIG. 24A and a position where the crimper 32 faces the binding position B1 illustrated in FIGS. 24B and 24C. The standby position HP is away in the main scanning direction from the sheet bundle Pb placed on the internal tray 22. For example, in FIGS. 17A to 17C, the standby position HP is distanced to the right of the sheet bundle Pb along the main scanning direction. The binding position B1 is a position on the sheet bundle Pb placed on the internal tray 22. However, the specific position of the binding position B1 is not limited to the position illustrated in FIGS. 24B and 24C. The binding position B1 may be one or more positions along the main scanning direction at the downstream end, in the conveyance direction, of the sheet P.

The posture of the crimper 32 changes or is pivoted between a parallel binding posture illustrated in FIG. 24B and an oblique binding posture illustrated in FIG. 24C. The parallel binding posture is a posture of the crimper 32 in which the longitudinal direction of the pair of binding teeth 32a and binding teeth 32b (in other words, the rectangular crimping binding trace) is oriented in the main scanning direction. The oblique binding posture is a posture of the crimper 32 in which the length of the pair of binding teeth 32a and binding teeth 32b (in other words, the rectangular crimp binding trace) is inclined with respect to the main scanning direction.

The pivot angle, which is an angle of the pair of binding teeth 32a and binding teeth 32b with respect to the main scanning direction, in the oblique binding posture is not limited to the angle illustrated in FIG. 24C. The pivot angle in the oblique binding posture may be any angle provided that the pair of binding teeth 32a and binding teeth 32b faces the sheet bundle Pb placed on the internal tray 22.

The post-processing apparatus 3A includes the liquid applier 131 and a hole punch 132 serving as a processor. The liquid applier 131 and the hole punch 132 are disposed upstream from the internal tray 22 in the opposite conveyance direction. In addition, the liquid applier 131 and the hole punch 132 are disposed at different positions in the opposite conveyance direction to simultaneously face one sheet P that is conveyed by the conveyance roller pairs 10 to 19. The liquid applier 131 and the hole punch 132 according to the present embodiment are disposed between the conveyance roller pairs 10 and 11. However, the arrangement of the liquid applier 131 and the hole punch 132 is not limited to the embodiment illustrated in FIG. 23. For example, in a case where an inserter 6 is disposed between the image forming apparatus 2 and the post-processing apparatus 3A as illustrated in FIG. 31, the liquid applier 131 may be disposed inside the inserter 6 located upstream from the post-processing apparatus 3A in a direction in which the sheet P is conveyed from the image forming apparatus 2 to the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

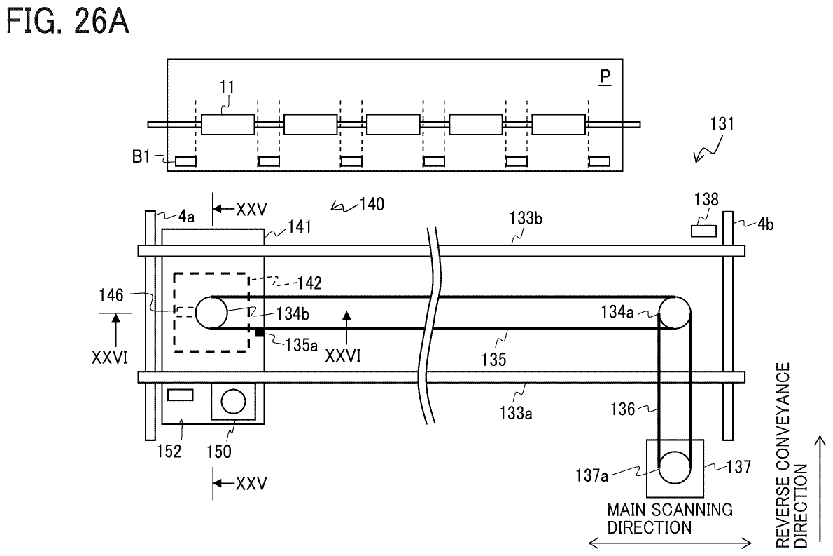

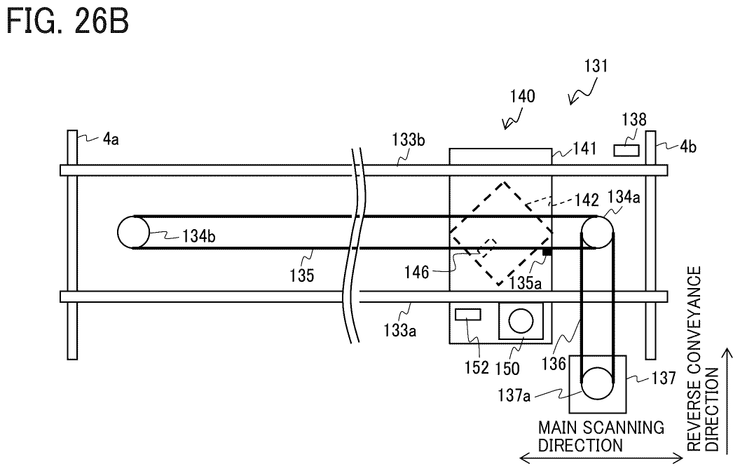

As illustrated in FIG. 26A, the conveyance roller pair 11 is located so as not to overlap, in the main scanning direction, the liquid application position B1 on the sheet P to which the liquid has been applied by a liquid application head 146 of the liquid applier 131. This is to prevent the amount of liquid at the liquid application position B1 from decreasing due to the plurality of roller pairs pressing the liquid application position B1 when the conveyance roller pair 11 conveys the sheet P. As a result, when the sheet P reaches the crimper 32 disposed downstream from the liquid applier 131 in the opposite conveyance direction, the amount of liquid at the liquid application position B1 is sufficient to maintain the binding strength. Accordingly, the binding strength of the sheet bundle Pb is prevented from decreasing due to a decrease in the amount of liquid at the liquid application position B1 while the sheet P is conveyed.

In addition, the plurality of roller pairs of the conveyance roller pair 11 that is located so as not to overlap the liquid application position B1 on the sheet P in the main scanning direction prevents the conveying performance of the sheet P from being worse due to the adhesion of liquid to the plurality of roller pairs and further prevents a conveyance jam caused by the worsened conveying performance of the sheet P.

Although only the conveyance roller pair 11 has been described above, the plurality of roller pairs of the conveyance roller pairs 14 and 15 are preferably located so as not to overlap the liquid application position B1 on the sheet P in the main scanning direction, like the plurality of roller pairs of the conveyance roller pair 11.

The liquid applier 131 applies liquid (for example, water) to the sheet P that is conveyed by the conveyance roller pairs 10 and 11. In the following description, the application of liquid may be referred to as “liquid application.” The hole punch 132 punches a hole in the sheet P that is conveyed by the conveyance roller pairs 10 and 11 such that the hole penetrates the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pairs 10 and 11.

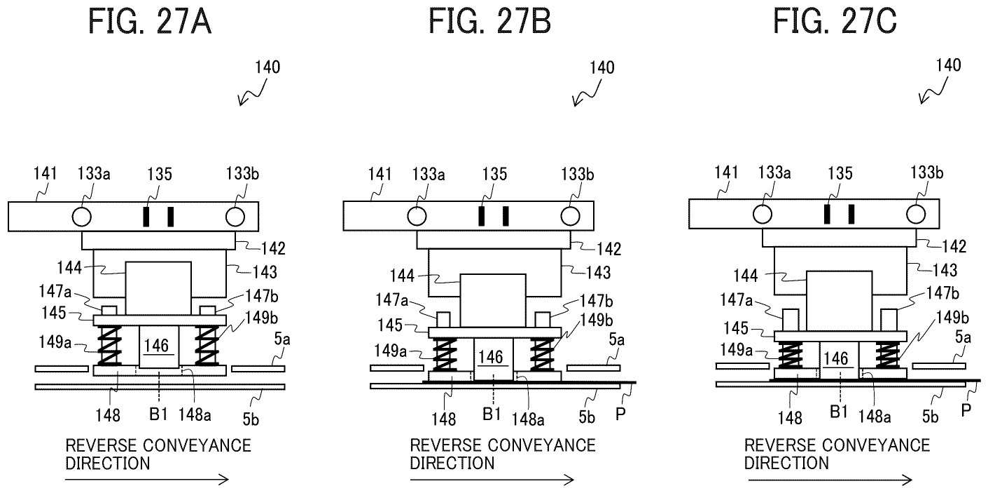

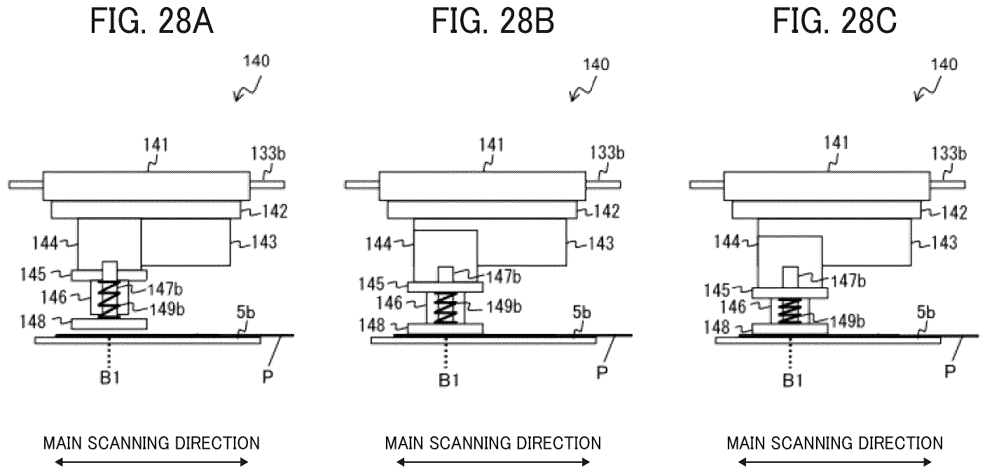

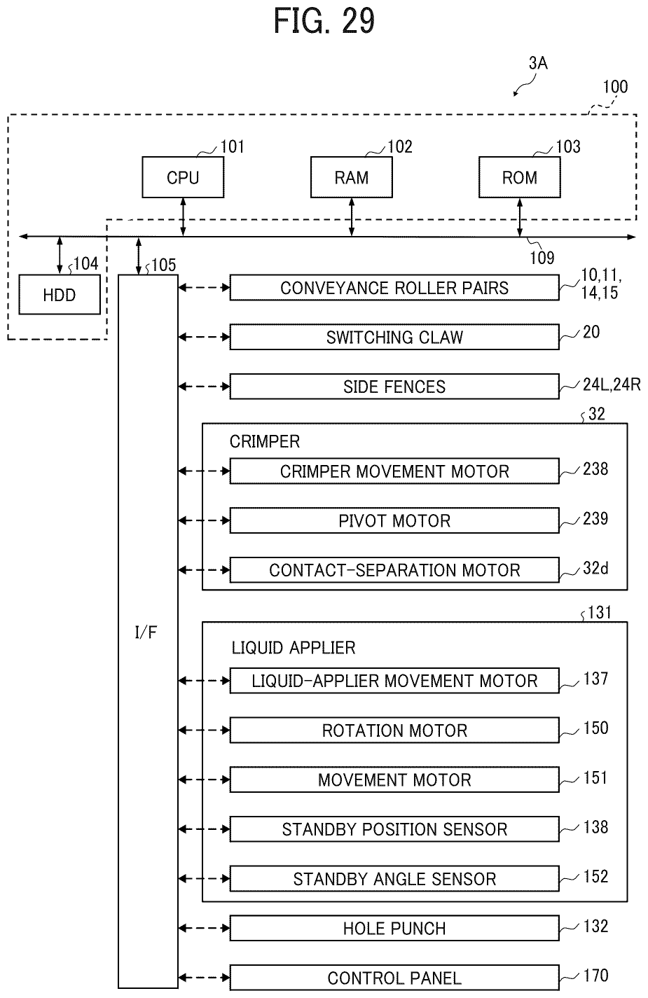

FIGS. 26A and 26B are views of the liquid applier 131 in the thickness direction of the sheet P, according to the second embodiment of the present disclosure. FIGS. 27A, 27B, and 27C are cross-sectional views of a liquid application unit 140 of the liquid applier 131 taken through XXV-XXV of FIG. 26A. FIGS. 28A, 28B, and 28C are cross-sectional views of the liquid application unit 140 of the liquid applier 131 taken through XXVI-XXVI of FIG. 26A. As illustrated in FIGS. 26A to 28C, the liquid applier 131 includes a pair of guide shafts 133a and 133b, a pair of pulleys 134a and 134b, endless annular belts 135 and 136, a liquid applier movement motor 137, a standby position sensor 138 (see FIG. 29), and a liquid application unit 140.

The guide shafts 133a and 133b, each extending in the main scanning direction, are apart from each other in the reverse conveyance direction. The pair of guide shafts 133a and 133b is supported by a pair of side plates 4a and 4b of the post-processing apparatus 3A. On the other hand, the pair of guide shafts 133a and 133b supports the liquid application unit 140 such that the liquid application unit 140 can move in the main scanning direction.

The pair of pulleys 134a and 134b is disposed between the guide shafts 133a and 133b in the reverse conveyance direction. On the other hand, the pulleys 134a and 134b are apart from each other in the main scanning direction. The pair of pulleys 134a and 134b is supported by a frame of the post-processing apparatus 3A so as to be rotatable about an axis extending in the thickness direction of the sheet P.

The endless annular belt 135 is entrained around the pair of pulleys 134a and 134b. The endless annular belt 135 is coupled to the liquid application unit 140 by a connection 135a. The endless annular belt 136 is entrained around the pulley 134a and a driving pulley 137a that is fixed to an output shaft of the liquid applier movement motor 137. The liquid applier movement motor 137 generates a driving force to move the liquid application unit 140 in the main scanning direction.

As the liquid applier movement motor 137 rotates, the endless annular belt 136 circulates around the pulley 134a and the driving pulley 137a to rotate the pulley 134a. As the pulley 134a rotates, the endless annular belt 135 circulates around the pair of pulleys 134a and 134b. As a result, the liquid application unit 140 moves in the main scanning direction along the pair of guide shafts 133a and 133b. The liquid application unit 140 reciprocates in the main scanning direction in response to the rotation direction of the liquid applier movement motor 137 being switched.

The standby position sensor 138 detects that the liquid application unit 140 has reached a standby position in the main scanning direction. The standby position sensor 138 then outputs a standby position signal indicating the detection result to the controller 100, which will be described below with reference to FIG. 28. The standby position sensor 138 is, for example, an optical sensor including a light emitting unit and a light receiving unit. The liquid application unit 140 at the standby position blocks an optical path between the light emitting unit and the light receiver. Then, the standby position sensor 138 outputs the standby position signal in response to the light output from the light emitter not being received by the light receiver. The specific configuration of the standby position sensor 138 is not limited to the configuration described above.

As illustrated in FIG. 27, the conveyance passage inside the post-processing apparatus 3A is defined by an upper guide plate 5a and a lower guide plate 5b, which are apart from each other in the thickness direction of the sheet P. The liquid application unit 140 is located to face an opening of the upper guide plate 5a. In other words, the liquid application unit 140 faces the conveyance passage through the opening of the upper guide plate 5a to face the sheet P conveyed along the conveyance passage.

As illustrated in FIGS. 26A to 28C, the liquid application unit 140 includes a base 141, a rotary bracket 142, a liquid storage tank 143, a mover 144, a holder 145, the liquid application head 146, columns 147a and 147b, a pressure plate 148, coil springs 149a and 149b, a rotary motor 150, a movement motor 151 illustrated in FIG. 29, and a standby angle sensor 152, which is also illustrated in FIG. 29.

The base 141 is supported by the pair of guide shafts 133a and 133b so as to be slidable in the main scanning direction. The base 141 is coupled to the endless annular belt 135 by the connection 135a. On the other hand, the base 141 supports the components of the liquid application unit 140 such as the rotary bracket 142, the liquid storage tank 143, the mover 144, the holder 145, the liquid application head 146, the columns 147a and 147b, the pressure plate 148, the coil springs 149a and 149b, the rotary motor 150, the movement motor 151, and the standby angle sensor 152.

The rotary bracket 142 is supported by a lower face of the base 141 so as to be pivotable about an axis extending in the thickness direction of the sheet P. The rotary bracket 142 is rotated with respect to the base 141 by a driving force transmitted from the rotary motor 150. On the other hand, the rotary bracket 142 supports the liquid storage tank 143, the mover 144, the holder 145, the liquid application head 146, the columns 147a and 147b, the pressure plate 148, and the coil springs 149a and 149b.

The standby angle sensor 152, which is also illustrated in FIG. 29, detects that the rotary bracket 142 has reached a standby angle. The standby angle sensor 152 then outputs a standby angle signal indicating the detection result to the controller 100. The standby angle is, for example, an angle for the parallel binding. The standby angle sensor 152 is, for example, an optical sensor including a light emitter and a light receiver. The rotary bracket 142 at the standby angle blocks an optical path between the light emitter and the light receiver. Then, the standby angle sensor 152 outputs the standby angle signal in response to the light output from the light emitter not being received by the light receiver. The specific configuration of the standby angle sensor 152 is not limited to the configuration described above.

Note that FIG. 26A illustrates the rotary bracket 142 in a position for the parallel binding that is performed by the crimper 32 disposed downstream from the liquid applier 131 in a direction in which the sheet P is conveyed. FIG. 26B illustrates the rotary bracket 142 in a position for the oblique binding (i.e., corner binding) that is performed by the crimper 32 disposed downstream from the liquid applier 131 in the direction in which the sheet P is conveyed.

The liquid storage tank 143 stores liquid to be applied to the sheet P. The mover 144 is supported by the liquid storage tank 143 so as to be movable (for example, up and down) in the thickness direction of the sheet P. The mover 144 is moved with respect to the liquid storage tank 143 by a driving force transmitted from the movement motor 151. The holder 145 is attached to a lower end of the mover 144. The liquid application head 146 projects from the holder 145 toward the conveyance passage (downward in the present embodiment). The liquid that is stored in the liquid storage tank 143 is supplied to the liquid application head 146. The liquid application head 146 is made of a material having a relatively high liquid absorption (for example, sponge or fiber).

The columns 147a and 147b project downward from the holder 145 around the liquid application head 146. The columns 147a and 147b can move relative to the holder 145 in the thickness direction. The columns 147a and 147b have respective lower ends holding the pressure plate 148. The pressure plate 148 has a through hole 148a at a position where the through hole 148a faces the liquid application head 146. The coil springs 149a and 149b are fitted around the columns 147a and 147b, respectively, between the holder 145 and the pressure plate 148. The coil springs 149a and 149b bias the columns 147a and 147b and the pressure plate 148 downward with respect to the holder 145.

As illustrated in FIGS. 27A and 28A, before the sheet P is conveyed to the position where the sheet P faces the opening of the upper guide plate 5a, the pressure plate 148 is positioned at or above the opening. Next, when the sheet P that is conveyed by the conveyance roller pairs and 11 stops at a position where the liquid application position B1 on the sheet P faces the opening, the movement motor 151 is rotated in a first direction. As a result, the mover 144, 10 the holder 145, the liquid application head 146, the columns 147a and 147b, the pressure plate 148, and the coil springs 149a and 149b are moved down together to allow the pressure plate 148 to contact the sheet P. Note that the liquid application position B1 corresponds to the binding position to be crimped and bound by the binder 25.

As the movement motor 151 keeps rotating in the first direction after the pressure plate 148 contacts the sheet P, the coil springs 149a and 149b are compressed to further move down the mover 144, the holder 145, the liquid application head 146, and the columns 147a and 147b. As a result, as illustrated in FIGS. 27B and 28B, a lower face of the liquid application head 146 contacts the sheet P through the through hole 148a. Then, the liquid contained in the liquid application head 146 is applied to the sheet P.

Further rotation of the movement motor 151 in the first direction further strongly presses the liquid application head 146 against the sheet P as illustrated in FIGS. 27C and 28C. Accordingly, the amount of liquid that is applied to the sheet P increases. In short, the liquid applier 131 changes the pressing force of the liquid application head 146 against the sheet P to adjust the amount of liquid that is applied to the sheet P.

On the other hand, the rotation of the movement motor 151 in a second direction opposite to the first direction moves up the mover 144, the holder 145, the liquid application head 146, the columns 147a and 147b, the pressure plate 148, and the coil springs 149a and 149b together. As a result, as illustrated in FIGS. 27A and 28A, the liquid application head 146 and the pressure plate 148 are separated from the sheet P. In other words, the liquid applier 131 includes the liquid application head 146 that can be separated from the sheet P.

FIG. 29 is a block diagram illustrating a hardware configuration of the post-processing apparatus 3A to control the operation of the post-processing apparatus 3A according to the second embodiment of the present disclosure. As illustrated in FIG. 28, the post-processing apparatus 3A includes the CPU 101, the RAM 102, the ROM 103, the HDD 104, and the I/F 105. The CPU 101, the RAM 102, the ROM 103, the HDD 104, and the I/F 105 are connected to each other via the common bus 109.

The CPU 101 is an arithmetic unit and controls the overall operation of the post-processing apparatus 3A. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 3A processes, for example, a control program stored in the ROM 103 and an information processing program (application program) loaded into the RAM 102 from a storage medium such as the HDD 104. Such processing configures a software controller including various functional modules of the post-processing apparatus 3A. The software controller thus configured cooperates with hardware resources of the post-processing apparatus 3A to construct functional blocks that implement functions of the post-processing apparatus 3A. In other words, the CPU 101, the RAM 102, the ROM 103, and the HDD 104 construct the controller 100 that controls the operation of the post-processing apparatus 3A.

The I/F 105 is an interface that connects the conveyance roller pairs 10, 11, 14, and 15, the switching claw 20, the side fences 24L and 24R, the crimper 32, the liquid applier 131, the hole punch 132, and the control panel 170 to the common bus 109. The controller 100 controls, via the I/F 105, the operations of the conveyance roller pairs 10, 11, 14, and 15, the switching claw 20, the side fences 24L and 24R, the crimper 32, the liquid applier 131, and the hole punch 132. Although FIG. 28 illustrates the components that execute the edge stitching process, the components that execute the saddle stitching process are also similarly controlled by the controller 100.

The control panel 170 includes an operating device that receives instructions input by a user and a display serving as a notifier that notifies the user of information. The operation unit as an input device includes, for example, hard keys and a touch screen overlaid on a display. The control panel 170 acquires information from the user through the operation unit and provides information to the user through the display.

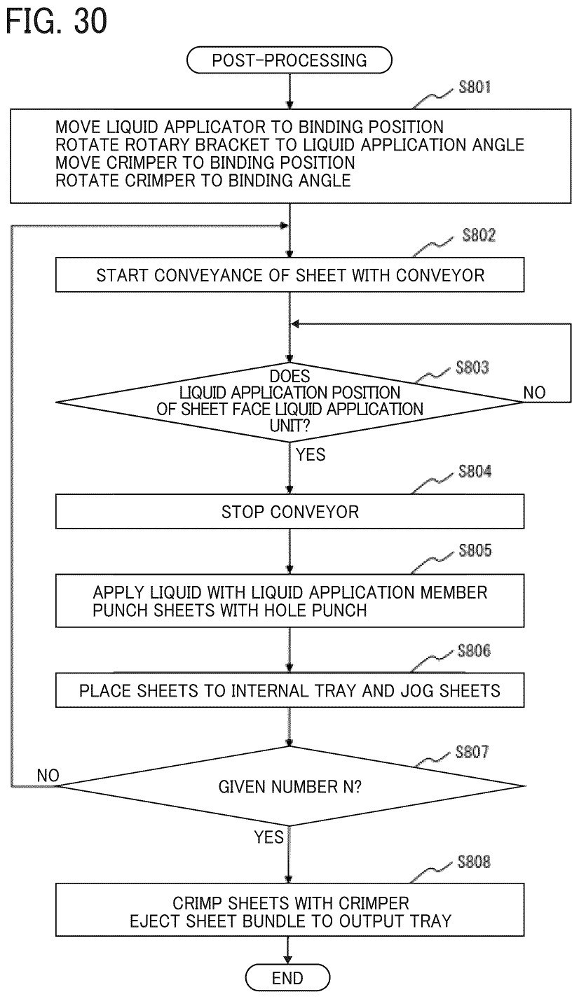

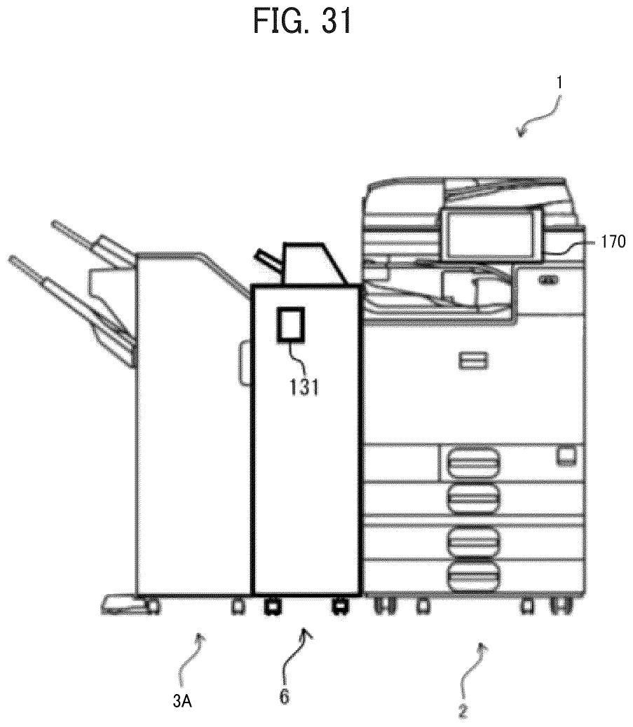

FIG. 30 is a flowchart of post-processing performed by the post-processing apparatus 3A according to the second embodiment. Specifically, FIG. 30 is a flowchart of a process to execute the one-point binding illustrated in FIGS. 24A to 24C.

For example, the controller 100 executes the post-processing illustrated in FIG. 30 when the controller 100 acquires an instruction to execute the post-processing from the image forming apparatus 2. In the following description, the instruction to execute the post-processing may be referred to as a “post-processing command.” The post-processing command includes, for example, the number of sheets P of the sheet bundle Pb, the binding position B1 (corresponding to the liquid application position B1), a binding angle (corresponding to a liquid application angle), and a process that is executed in parallel with the liquid application process (i.e., punching a hole in the present embodiment). In the following description, the number of sheets P of the sheet bundle Pb may be referred to as a “given number N.” Note that, at the start of the post-processing, the liquid application unit 140 is at the standby position HP corresponding to the standby position HP illustrated in FIG. 24A whereas the rotary bracket 142 is held at the standby angle.

First, in step S801, the controller 100 drives the liquid applier movement motor 137 to move the liquid application unit 140 in the main scanning direction such that liquid application head 146 moves from the standby position HP to a position where the liquid application head 146 can face the liquid application position B1 corresponding to the binding position B1 illustrated in FIGS. 24B and 24C. In addition, in step S801, the controller 100 drives the rotary motor 150 to rotate the rotary bracket 142 such that the liquid application head 146 rotates from the standby angle to the liquid application angle. It is ascertained based on a pulse signal output from a rotary encoder of the liquid applier movement motor 137 that the liquid application head 146 has reached the position where the liquid application head 146 can face the liquid application position B1. Similarly, it is ascertained based on a pulse signal output from a rotary encoder of the rotary motor 150 that the liquid application head 146 has reached the liquid application angle.

Further, in step S801, the controller 100 drives the crimper movement motor 238 to move the crimper 32 from the standby position HP to the position where the crimper 32 can face the binding position B1 as illustrated in FIGS. 24A and 24B. Furthermore, in step S801, the controller 100 drives the pivot motor 239 to rotate the crimper 32 from the standby angle to the binding angle, which may be referred to as a crimp binding angle in the following description. It is ascertained based on a pulse signal output from a rotary encoder of the crimper movement motor 238 that the crimper 32 has reached the position where the crimper 32 can face the binding position B1. Similarly, it is ascertained based on a pulse signal output from a rotary encoder of the pivot motor 239 that the crimper 32 has reached the crimp binding angle.

Subsequently, in step S802, the controller 100 drives the conveyance roller pairs 10 and 11 to start conveying the sheet P on which an image is formed by the image forming apparatus 2. In step S803, the controller 100 determines whether the liquid application position B1 on the sheet P has faced the liquid application unit 140 (more specifically, the liquid application head 146). When the liquid application position B1 on the sheet P has not faced the liquid application head 146 (NO in step S803), the controller 100 repeats the determination in step S803. In other words, the controller 100 continues driving the conveyance roller pairs 10 and 11 until the liquid application position B1 on the sheet P faces the liquid application head 146. By contrast, when the liquid application position B1 on the sheet P has faced the liquid application head 146 (YES in step S803), in step S804, the controller 100 stops the conveyance roller pairs 10 and 11. It is ascertained based on a pulse signal output from a rotary encoder of a motor that drives the conveyance roller pairs 10 and 11 that the liquid application position B1 on the sheet P has faced the liquid application head 146.

In step S805, the controller 100 executes the process of applying the liquid to the liquid application position B1 on the sheet P with the liquid applier 131 and the process of punching a hole in the sheet P with the hole punch 132 in parallel. More specifically, the controller 100 rotates the movement motor 151 in the first direction to bring the liquid application head 146 into contact with the liquid application position B1 on the sheet P. In addition, the controller 100 changes the pressing force of the liquid application head 146 (in other words, the amount of rotation of the movement motor 151) depending on the amount of liquid that is applied to the sheet P.

The amount of liquid that is applied to the sheet P may be the same for all the sheets P of the sheet bundle Pb or may be different for each sheet P. For example, the controller 100 may apply a decreased amount of liquid to the sheet P conveyed later. The amount of rotation of the movement motor 151 may be ascertained based on a pulse signal output from a rotary encoder of the movement motor 151.

In step S806, the controller 100 drives the conveyance roller pairs 10, 11, 14, and 15 to place the sheet P on the internal tray 22. The controller 100 moves the side fences 24L and 24R to align the position of the sheet bundle Pb placed on the internal tray 22 in the main scanning direction. In short, the controller 100 performs so-called jogging.

In step S807, the controller 100 determines whether or not the number of sheets P placed on the internal tray 22 has reached the given number N of sheets indicated by the post-processing command. When the controller 100 determines that the number of sheets P placed on the internal tray 22 has not reached the given number N of sheets (NO in step S807), the controller 100 executes the operations of steps S802 to S806 again.

By contrast, when the controller 100 determines that the number of sheets P that are placed on the internal tray 22 has reached the given number N of sheets (YES in step S807), in step S808, the controller 100 causes the crimper 32 to crimp and bind the binding position B1 (corresponding to the liquid application position B1) on the sheet bundle Pb to which the liquid has been applied by the liquid applier 131. In addition, in step S808, the controller 100 rotates the conveyance roller pair 15 to output the sheet bundle Pb thus crimped and bound to the output tray 26.

Then, the controller 100 drives the liquid applier movement motor 137 to move the liquid applier 131 to the standby position HP and drives the crimper movement motor 238 to move the crimper 32 to the standby position HP.

The control method described above may be implemented by, for example, a program. That is, the control method may be executed by causing an arithmetic device, a storage device, an input device, an output device, and a control device to operate in cooperation with each other based on a program. In addition, the program may be written in, for example, a storage device or a storage medium and distributed, or may be distributed through, for example, an electric communication line.

The present disclosure is not limited to specific embodiments described above, and numerous additional modifications and variations are possible in light of the teachings within the technical scope of the appended claims. It is therefore to be understood that the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

Now, a description is given of some aspects of the present disclosure.

Initially, a description is given of a first aspect.

A medium processing apparatus includes: a liquid applier including a liquid application member to apply liquid to a part of at least one medium; a crimper to press and deform a bundle of media including the at least one medium to which the liquid is applied by the liquid applier, to bind the bundle of media; and a controller to cause the liquid application member to move with respect to the media, based on the height information of the medium, so that an amount of the liquid applied to the medium by the liquid application member is equal to a designated amount.

Now, a description is given of a second aspect.

In the medium processing apparatus according to the first aspect, the controller changes a movement amount of the liquid application member, based on the height information of the medium, so that the amount of the liquid applied to the medium by the liquid application member is equal to the designated amount.

Now, a description is given of a third aspect.

In the medium processing apparatus according to the first aspect, the controller changes a movement start position of the liquid application member, based on the height information of the medium, so that the amount of the liquid applied to the medium by the liquid application member is equal to the designated amount, and sets a movement amount of the liquid application member to a predetermined value.

Now, a description is given of a fourth aspect.

In the medium processing apparatus according to the first aspect, the controller changes a movement amount of the liquid application member, based on the height information of the medium, so that the amount of the liquid applied to the medium by the liquid application member is equal to the designated amount, and sets a movement start position of the liquid application member to a predetermined position.

Now, a description is given of a fifth aspect.

In the medium processing apparatus according to any one of the first to fourth aspects, the controller acquires a height of the medium, based on the number of media including the medium on execution of liquid application and a thickness per medium of the media. Now, a description is given of a sixth aspect.

In the medium processing apparatus according to the fifth aspect, the controller acquires the thickness one by one for each of the media.

Now, a description is given of a seventh aspect.

In the medium processing apparatus according to any one of the first to sixth aspects, the controller acquires the height of the medium, based on a distance from a contact surface of the liquid application member with the medium to an uppermost surface of media including the medium on execution of liquid application.

Now, a description is given of an eighth aspect.

The medium processing apparatus according to any one of the first to seventh aspects further includes a conveyor to convey the medium. The conveyor includes a conveyance path to convey the medium and a retreat conveyance path different from the conveyance path. The conveyor temporarily conveys a preceding medium to which the liquid is not applied by the liquid applier to the retreat conveyance path, and then conveys the preceding medium and a subsequent medium overlaid with the preceding medium. When the liquid is applied to the subsequent medium overlaid with the preceding medium, the controller controls the movement amount of the liquid application member with respect to the medium, based on a combined height of the preceding medium and the subsequent medium on execution of liquid application.

Now, a description is given of a ninth aspect.

An image forming system includes: an image forming apparatus including an image forming unit to form images on a plurality of media; and the medium processing apparatus according to any one of the first to eighth aspects, to crimp and bind the plurality of media on which the images are formed by the image forming unit.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

This patent application is based on and claims priority pursuant to 35 U.S.C. § 119 (a) to Japanese Patent Application No. 2022-017347, filed on Feb. 7, 2022, and Japanese Patent Application No. 2022-193643 filed on Dec. 2, 2022, in the Japan Patent Office, the entire disclosure of each of which is hereby incorporated by reference herein.

### REFERENCE SIGNS LIST

1: Image forming system
2: Image forming apparatus
3: Post-processing apparatus
25: Binder
31: Liquid applier
32: Crimper
33: Lower pressure plate
35: Liquid applier movement assembly
36: Liquid application assembly
37: Liquid applier movement motor
43: Liquid storage tank
44: Liquid application member
47: Bindier movement assembly
48: Base
49: Guide shaft
50: Binder movement motor
51: Driving force transmission assembly
100: Controller
250: Overlay conveyance section
251: Upstream conveyance roller pair
252: Downstream conveyance roller pair
253: Contact-separation conveyance roller pair
254: Retreat conveyance roller pair
255: Internal-tray ejection roller pair
257: Medium detection sensor
260: Internal tray
270: Distance measuring sensor
Ms: Movement start position
Msd: Movement-start initial position
Mv: Movement amount
Mvd: Initial movement amount
N: Given number
P: Sheet
PU: Hole punch
Pd: Displacement amount
Pdp: Prestack adjustment amount

1. A medium processing apparatus, comprising:
a liquid applier including a liquid application member, the liquid applier configured to apply liquid to a part of a medium;
a crimper configured to bind a bundle of media, the binding the bundle of media including pressing and deforming the bundle of media to which the liquid is applied by the liquid applier, the bundles of media including the medium; and
processing circuitry configured to cause the liquid application member to move with respect to the medium, based on height information of the medium, so that an amount of the liquid applied to the medium is equal to a designated amount.

2. The medium processing apparatus according to claim 1, wherein the processing circuitry is further configured to:
change a movement amount of the liquid application member, based on the height information of the medium, so that the amount of the liquid applied to the medium is equal to the designated amount.

3. The medium processing apparatus according to claim 1, wherein the processing circuitry is further configured to:
change a movement start position of the liquid application member; based on the height information of the medium, so that the amount of the liquid applied to the medium is equal to the designated amount and
set a movement amount of the liquid application member to a desired value.

4. The medium processing apparatus according to claim 1, wherein the processing circuitry is further configured to:
changes a movement amount of the liquid application member, based on the height information of the medium, so that the amount of the liquid applied to the medium by the liquid application member is equal to the designated amount, and sets a movement start position of the liquid application member to a predetermined position.

5. The medium processing apparatus according to claim 1, wherein the processing circuitry is further configured to:
acquire a height of the medium based on a number of media included in the bundle of media and a thickness of each medium included in the bundle of media.

6. The medium processing apparatus according to claim 5, wherein the processing circuitry is further configured to:
acquire the thickness one by one for each the bundle of media.

7. The medium processing apparatus according to claim 1, wherein the processing circuitry is configured to:
acquire a height of the medium; based on a distance from a contact surface of the liquid application member to an uppermost surface of the bundle of media.

8. The medium processing apparatus according to claim 1, further comprising:
a conveyor configured to convey the medium, the conveyor including a conveyance path and a retreat conveyance path different from the conveyance path, the conveyor is further configured to temporarily conveys a preceding medium to which the liquid is not applied by the liquid applier to the retreat conveyance path, and then conveys the preceding medium and a subsequent medium overlaid with the preceding medium and
in response to the liquid being applied to the subsequent medium overlaid with the preceding medium, the processing circuitry is further configured to controls a movement amount of the liquid application member with respect to the medium based on a combined height of the preceding medium and the subsequent medium on execution of liquid application.

9. An image forming system, comprising:
an image forming apparatus to form images on a plurality of media; and
the medium processing apparatus according to claim 1, the medium processing apparatus configured to crimp and bind the plurality of media on which the images are formed by the image forming apparatus.
